(19) United States
(12) Patent Application Publication
(10) Pub. No.: US 2014/0293779 A1
(43) Pub. Date: Oct. 2, 2014

(54) ROUTE SELECTING APPARATUS, ROUTE SELECTING METHOD, AND COMMUNICATION SYSTEM

(71) Applicant: FUJITSU LIMITED, Kawasaki-shi (JP)

(72) Inventors: Masaharu KAKO, Toukai (JP); Satoshi Maehara, Yokohama (JP)

(73) Assignee: FUJITSU LIMITED, Kawasaki-shi (JP)

(21) Appl. No.: 14/166,989

(22) Filed: Jan. 29, 2014

(30) Foreign Application Priority Data
Mar. 29, 2013 (JP) 2013-075147

(51) Int. Cl. H04W 40/36; H04W 36/02

(52) U.S. Cl. CPC H04W 40/36; H04W 36/026; H04W 36/02
USPC 370/230

(57) ABSTRACT

A first route selecting apparatus that is included among a plurality of route selecting apparatuses includes an acquiring unit that acquires for handover of communication currently relayed by the first route selecting apparatus, a selection state of a relay route of a second route selecting apparatus that is included among the route selecting apparatuses that each selects from among a first route and a second route, a relay route between a mobile terminal and a communication destination, and that when a traffic amount of the first route becomes at least a predetermined amount, selects the second route for communication established for a communication request issued thereafter; and a selecting unit that according to the acquired selection state, selects the second route for the currently relayed communication even when the traffic amount of the first route is less than the predetermined amount.

### CROSS REFERENCE TO RELATED APPLICATIONS

This application is based upon and claims the benefit of priority of the prior Japanese Patent Application No. 2013-075147, filed on Mar. 29, 2013, the entire contents of which are incorporated herein by reference.

### FIELD

The embodiments discussed herein are related to a route selecting apparatus, a route selecting method, and a communication system.

### BACKGROUND

Radio communication systems such as portable telephone systems and radio metropolitan area networks (MANs) are currently used. In the field of the radio communication, discussions are held about the next-generation communication technology to further improve communication speed and communication capacity.

For example, long term evolution/evolved packet core (LTE/EPC) is present concerning radio communication systems. The LTE/EPC is standardized based on the 3rd generation partnership project (3GPP) as the next-generation radio communication system after the 3G mobile system.

The LTE/EPC includes LTE networks and an EPC network as a core network. The LTE network is, for example, a radio access network conforming to the LTE, and may also be referred to as “evolved UMTS terrestrial radio access network (E-UTRAN)”. The EPC network is also referred to as “system architecture evolution (SAE)”, and is connected to an Internet packet (IP) network (or a packet network) through an IP multimedia subsystem (IMS) network. The IP network is, for example, an Internet service provider (ISP) network (or the Internet) or an intranet.

In the LTE/EPC, a mobile terminal (user equipment: UE) can be connected to the EPC network through the LTE network and can be connected to the IP network through the EPC network and the IMS network. The mobile terminal can receive various types of services such as a service for viewing a browser, a service for distributing video images, and voice over IP (VOIP) by accessing various types of server apparatuses and terminal apparatuses connected to the IP network.

The EPC network includes plural nodes such as a mobile management entity (MME), a serving gateway (S-GW), a packet data network gateway (P-GW), and a “policy and charging rule function (PCRF)”. The mobile terminal can access the IP network by connecting to the IMS network through the S-GW and the P-GW.

On the other hand, a technique is present that is for these radio communication systems and referred to as “traffic off-loading”. Traffic off-loading facilitates reduction of the traffic in the EPC network by, for example, causing the traffic from a mobile terminal to arrive in the ISP network without passing through the S-GW and the P-GW.

According to the traffic off-loading technique, for example, an off-loading apparatus is disposed in the EPC network. The off-loading apparatus functions as an anchor point for the traffic from the mobile terminal (the radio access network), and transfers the traffic from the mobile terminal to a network that is for off-loading and different from the EPC network. A network for off-loading may be referred to as, for example, “off-loading network (the IP network, a multi-protocol label switching (MPLS) network, etc.)”. The off-load traffic arrives in the target IP networks through the off-loading network.

For the off-load traffic in the EPC network, for example, an off-loading apparatus to be an anchor point for the off-loading is determined for each communication line when the communication line is set in the mobile terminal. The off-loading apparatus to be the anchor point is not changed when the base station connected to the mobile terminal is changed. The overall off-load traffic from the mobile terminal passes through the off-loading apparatus that is the anchor point. Thereby, for example, any disconnection and any disruption of communication caused by the movement of the mobile terminal can be prevented between the mobile terminal and the IP network.

A technique is known of determining a starting point and an ending point of a bypass based on a traffic amount to be bypassed and traffic exchange information on a link for bypassing (see, e.g., Japanese Laid-Open Patent Publication No. 2009-200995). Another technique is known for an IP router detecting congestion to alleviate the congestion using a short-cut path (see, e.g., Japanese Laid-Open Patent Publication No. 2002-064554).

However, according to the conventional techniques, when a route selecting apparatus switches associated with a handover of a mobile terminal, congestion at the handover destination may not be suppressed.

### SUMMARY

According to an aspect of an embodiment, a first route selecting apparatus that is included among route selecting apparatuses includes an acquiring unit that acquires for handover of communication currently relayed by the first route selecting apparatus, a selection state of a relay route of a second route selecting apparatus that is included among the route selecting apparatuses that each selects from among a first route and a second route, a relay route between a mobile terminal and a communication destination, and that when a traffic amount of the first route becomes at least a predetermined amount, selects the second route for communication established for a communication request issued thereafter; and a selecting unit that according to the acquired selection state, selects the second route for the currently relayed communication even when the traffic amount of the first route is less than the predetermined amount.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of an example of a communication system according to a first embodiment;

FIG. 2 is a diagram of an example of a network system according to a second embodiment;

FIG. 3 is a diagram of an example of communication quality with handover;

FIG. 4 is a diagram of an example of determination of route switching based on geographical position relation;

FIG. 5 is a diagram of an example of a hardware configuration of an off-load GW;

FIG. 6 is a diagram of an example of a functional configuration of the off-load GW;

FIG. 7 is a diagram (Part I) of an example of operations executed by units of the off-load GW;

FIG. 8 is a diagram (Part II) of an example of operations executed by the units of the off-load GW;

FIG. 9 is a diagram of an example of communication route condition data;

FIG. 10 is a diagram of an example of allocating-point traffic route condition data;

FIG. 11 is a diagram of an example of peripheral apparatus route condition data;

FIG. 12 is a diagram of an example of a peripheral apparatus traffic route condition communication route switching threshold value;

FIG. 13 is a diagram of an example of a peripheral apparatus traffic route condition notification release threshold value;

FIG. 14 is a diagram of an example of an allocating-point traffic route condition switching threshold value;

FIG. 15 is a diagram of an example of off-load GW information on the off-load GW accommodating an eNB;

FIGS. 16A, 16B, and 16C are diagrams of an example of off-load condition data;

FIGS. 17A, 17B, and 17C are diagrams of an example of a bearer-using subscriber identification table;

FIG. 18 is a diagram of an example of a route state notification reception participation packet;

FIG. 19 is a diagram of an example of a route state notification reception participation packet;

FIG. 20 is a diagram of an example of a route state notification packet;

FIG. 21 is a diagram of an example of “Handover Required”;

FIG. 22 is a diagram of an example of a GTP-u packet;

FIG. 23 is a diagram of an example of a packet from the off-load GW to a web server through an off-load network;

FIG. 24 is a diagram of an example of “Handover Request” based on X2AP;

FIGS. 25A and 25B are a flowchart of an example of a process executed when an uplink GTP-u packet addressed to an S-GW is received;

FIG. 26 is a flowchart of an example of a process executed when “Handover Required” is intercepted;

FIGS. 27A and 27B are a flowchart of an example of a process executed when “Handover Request” is received based on the X2AP;

FIG. 28 is a flowchart of an example of an off-load communication address capture operation at step S2705 of FIGS. 27A and 27B;

FIG. 29 is a flowchart of an example of a binding update operation at step S2709 depicted in FIGS. 27A and 27B;

FIG. 30 is a flowchart of an example of an allocating-point traffic measurement process;

FIG. 31 is a flowchart of an example of a process executed when a route state notification packet is received;

FIG. 32 is a flowchart of an example of a route switching process;

FIG. 33 is a flowchart of an example of a route state reception release process;

FIGS. 34A and 34B are sequence diagrams of an example of operations of a network system, executed when TCP communication is off-loaded;

FIGS. 35A and 35B are sequence diagrams of an example of an S1-based handover process;

FIGS. 36A and 36B are sequence diagrams of an example of an X2-based handover process;

FIGS. 37A and 37B are diagrams of an example of a state before a first handover session;

FIGS. 38A and 38B are diagrams of an example of a state after the first handover session;

FIGS. 39A and 39B are diagrams of an example of a state after route switching due to traffic of a first route at a handover destination off-load GW;

FIGS. 40A and 40B are diagrams of an example of a state after route switching back due to the traffic of the first route at the handover destination off-load GW;

FIGS. 41A and 41B are diagrams of an example of a state after route switching back due to the traffic of the first route at a peripheral apparatus; and

FIGS. 42A and 42B are diagrams of an example of a state where a predetermined time period has elapsed since a final handover time.

### DESCRIPTION OF EMBODIMENTS

Embodiments of a route selecting apparatus, a route selecting method, and a communication system will be described in detail with reference to the accompanying drawings.

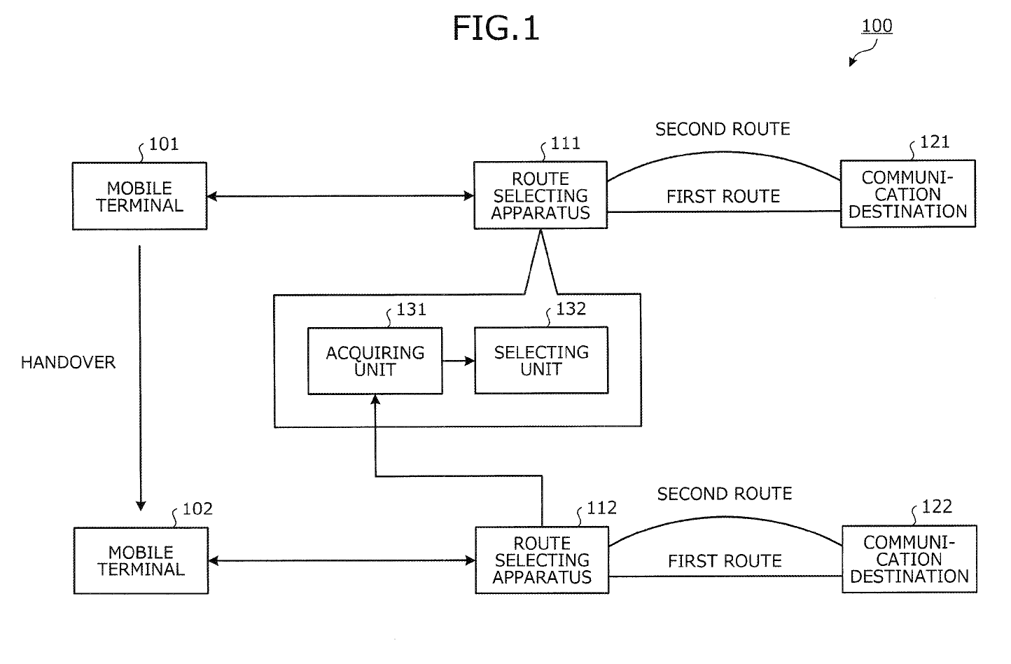

FIG. 1 is a diagram of an example of a communication system according to a first embodiment. As depicted in FIG. 1, the communication system 100 according to the first embodiment includes mobile terminals 101 and 102, route selecting apparatuses 111 and 112, and communication destinations 121 and 122.

The mobile terminal 101 executes communication with the communication destination 121 by executing, for example, radio communication with a base station. The route selecting apparatus 111 relays the communication between the mobile terminal 101 and the communication destination 121; and selects a relay route for communication between the mobile terminal 101 and the communication destination 121, from among a first route and a second route connected to the route selecting apparatus 111 and switches the relay route to the selected route.

For example, when the traffic amount of the first route becomes greater than or equal to a predetermined amount, the route selecting apparatus 111 selects the second route for communication between the mobile terminal 101 and the communication destination 121 requested by a communication request issued thereafter. Thereby, the traffic amount of the first route is reduced.

The mobile terminal 102 executes communication with the communication destination 122 by executing, for example, radio communication with a base station. The communication destination 122 may be the communicating apparatus that is same as the communication destination 121 or may be a communication apparatus that is different therefrom.

The route selecting apparatus 112 relays communication between the mobile terminal 102 and the communication destination 122; and selects a relay route for the communication between the mobile terminal 102 and the communication destination 122, from among a first route and a second route connected to the route selecting apparatus 112 and switches the relay route to the selected route.

The first route connected to the route selecting apparatus 112 may be the route that is the same as the first route connected to the route selecting apparatus 111 or may be a route different from the first route connected thereto. The second route connected to the route selecting apparatus 112 may be the route that is the same as the second route connected to the route selecting apparatus 111 or may be a route different from the second route connected thereto.

Similar to the route selecting apparatus 111, when the traffic amount of the first route becomes greater than or equal to the predetermined amount, the route selecting apparatus 112 selects the second route for communication between the mobile terminal 102 and the communication destination 122 requested by a communication request issued thereafter. Thereby, the traffic amount of the first route is reduced.

In the example depicted in FIG. 1, a case will be described, for example, where the mobile terminal 101 moves and the base station executing the radio communication with the mobile terminal 101 is switched and thereby, the apparatus relaying the communication with the mobile terminal 101 is switched from the route selecting apparatus 111 to the route selecting apparatus 112. In this case, the relay route selected by the route selecting apparatus 111 for the communication of the mobile terminal 101 (the first or the second route) is handed over to the route selecting apparatus 112.

For example, when the route selecting apparatus 111 selects the first route for the communication of the mobile terminal 101 and the mobile terminal 101 executes the handover, the handover destination route selecting apparatus 112 also selects the first route for the communication of the mobile terminal 101. When the route selecting apparatus 111 selects the second route for the communication of the mobile terminal 101 and the mobile terminal 101 executes the handover, the handover destination route selecting apparatus 112 also selects the second route for the communication of the mobile terminal 101.

The route selecting apparatus 111 includes an acquiring unit 131 and a selecting unit 132. The acquiring unit 131 acquires a selection state of each of the relay routes (the first and the second routes) at the route selecting apparatus 112 (another route selecting apparatus) for the handover of the communication between the mobile terminal 101 and the communication destination 121 currently relayed by the route selecting apparatus 111 (the apparatus), and notifies the selecting unit 132 of the acquired selection state.

The selecting unit 132 selects the second route for the communication between the mobile terminal 101 and the communication destination 121 currently relayed by the route selecting apparatus 111 (the apparatus) corresponding to the selection state notified of from the acquiring unit 131 even when the traffic amount of the first route is smaller than the predetermined amount. For example, in a case where the route selecting apparatus 112 selects the second route, even when the traffic amount of the first route of the route selecting apparatus 111 is smaller than the predetermined amount, the selecting unit 132 selects the second route for the communication of the mobile terminal 101.

Thereby, when the handover destination route selecting apparatus 112 selects the second route due to the congestion of the first route, the handover can be executed after the handover source route selecting apparatus 111 selects the second route. Thereby, the first route of the route selecting apparatus 112 can be prevented from being further congested.

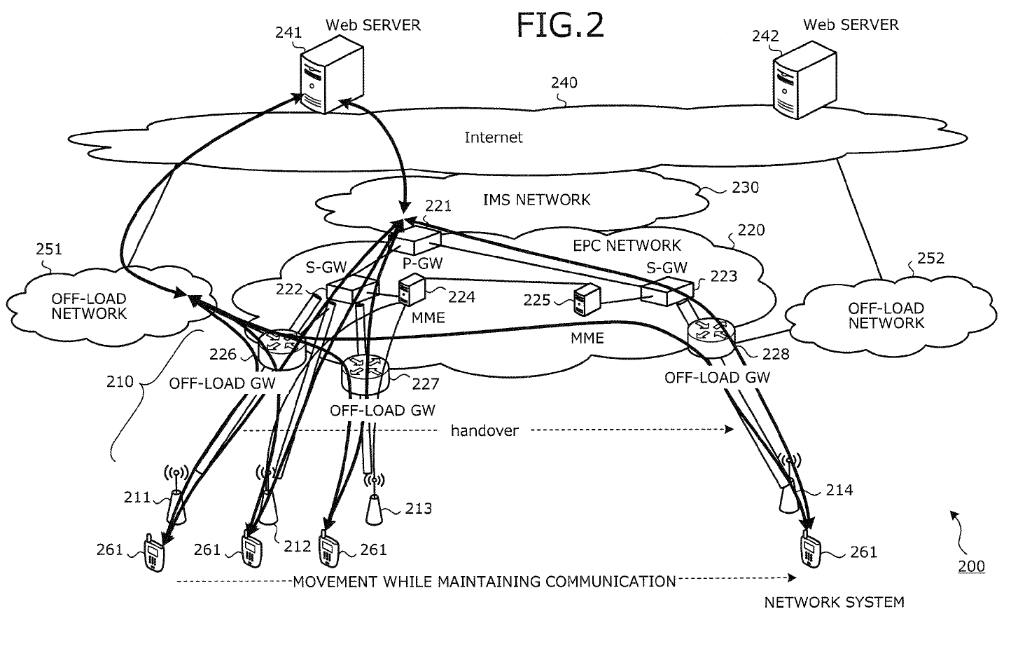

FIG. 2 is a diagram of an example of a network system according to a second embodiment. As depicted in FIG. 2, the network system 200 according to the second embodiment includes an LTE network 210, an EPC network 220, an IMS network 230, an ISP network 240 (the Internet), and off-load networks 251 and 252. FIG. 2 depicts the state of a change of the communication route in a case where, in the communication between a mobile terminal 261 that is a mobile terminal and a web server 241 of the ISP network, the mobile terminal 261 moves from a cell of a base station 211 to a cell of a base station 214, while maintaining the communication.

The LTE network 210 is a radio access network, and includes base stations 211 to 214. Each of the base stations 211 to 214 is, for example, a radio base station apparatus referred to as “evolved node B (eNodeB)” and conforming to the LTE.

The EPC network 220 is a core network and can accommodate, for example, radio access networks based on the 3GPP such as those of the second generation (2G), the third generation (3G), and the 3.5-th generation. The second generation radio access network can be applied with, for example, the global system for mobile communications (GSM). “GSM” is a registered trademark. The third generation radio access network can be applied with, for example, the wideband code division multiple access (W-CDMA). The 3.5-th generation radio access network can be applied with, for example, the high speed packet access (HSPA).

The EPC network 220 can also accommodate non-3GPP radio access networks such as those based on the CDMA2000 and the wideband interoperability for microwave access (WiMAX). “WiMax” is a registered trademark.

The EPC network 220 includes a P-GW 221, S-GWs 222 and 223, MMES 224 and 225, and off-load GWs 226 to 228. The EPC network 220 may further include nodes such as a PCRF.

The P-GW 221 acts as, for example, a connection point to a packet network such as the ISP network 240; executes, for example, paying out of an IP address to the mobile terminal 261 and user authentication; executes, for example, quality of service (Qos) control and billing data production according to instructions of the PCRF; and may have a dynamic host configuration protocol (DHCP) server function.

The S-GWs 222 and 223: each handle, for example, data in the user plane (U-plane) such as user data; each function as, for example, an anchor point of a 3GPP radio access network; and each execute a relay process of packet data with the P-GW 221.

The MMES 224 and 225 each handles, for example, control plane (C-plane) data concerning the network control; each executes, for example, establishment and release of a bearer, position registration of the mobile terminal 261, movement control such as a handover, etc.; and each executes authentication of the mobile terminal 261 in cooperation with, for example, a home subscriber server (HSS) having subscriber information registered therein.

Each of the off-load GWs 226 to 228 functions as, for example, a node controlling the off-load traffic. The EPC network 220 includes one or more off-loading apparatus(es). The off-load GWs 226 to 228 are disposed between, for example, the base stations 211 to 214 and the S-GWs 222 and 223. The number of the off-load GWs can be set arbitrarily and the off-load GW can be disposed at each of the base stations 211 to 214.

The off-load GWs 226 to 228 each intercepts C-plane packets transmitted and received between the base stations 211 to 214 and the S-GWs 222 and 223; and each determines the traffic to be off loaded (hereinafter, may be referred to as “off-load traffic”) of the U-plane traffic transmitted and received between the base stations 211 to 214 and the S-GWs 222 and 223.

After determining the traffic that is to be off loaded, the off-load GWs 226 to 228 each transmits and receives the off-load traffic in, for example, the following manner. The off-load GWs 226 to 228 branch the U-plane data (user packet) of the off-load traffic in the uplink communication transmitted from the mobile terminal 261, and transfer the U-plane data to the off-load networks 251 and 252 (the off-load network 251 in FIG. 2).

The traffic transferred to the off-load networks 251 and 252 is transmitted to the ISP network 240 without passing through the EPC network 220 and arrives at the target communication counterpart (for example, the web server 241). On the other hand, the off-load GWs 226 to 228 cause the off-load traffic of the downlink communication transmitted from the target communication counterpart to join the traffic from the S-GWs 222 and 223 to the base stations 211 to 214. An example of configuration of each of the off-load GWs 226 to 228, etc., will be described later.

The ISP network 240 is connected to the web servers 241 and 242 that respectively provide web sites #a and #b. The web servers 241 and 242 are each an example of the communication counterpart (Correspondence Node) of the mobile terminal 261 and may be, for example, a terminal apparatus that executes TCP communication.

The base stations 211 to 214 convert data from the web servers 241 and 242 through the off-load GWs 226 to 228 into radio signals; transmit the radio signals to the mobile terminal 261. The base stations 211 to 214 convert radio signals transmitted from the mobile terminal 261 into data, etc., and transmit the data to the web servers 241 and 242 through the off-load GWs 226 to 228.

The base stations 211 to 214 are connected to the MMEs 224 and 225 by a U-plane interface referred to as “S1-MME interface”, through the off-load GWs 226 to 228; and are connected to the S-GWs 222 and 223 by an interface referred to as “S1-U interface”. On the other hand, the S-GWs 222 and 223, and the MMEs 224 and 225 are connected to each other by a C-plane interface referred to as “S11 interface”. The S-GWs 222 and 223, and the P-GW 221 are connected to each other by an interface referred to as “S5”. The base stations 211 to 214 are connected to each other by an interface referred to as “X2 interface”.

The mobile station 261 can sequentially switch the connection destination base station thereof from the base station 211 to the base station 212 to the base station 213. This switching among the connection destination base stations 211 to 214 by the mobile terminal 261 may be referred to as “handover”.

Types of handover include an S1-based handover that is executed between different MMEs 224 and 225, and an X2-based handover that is executed in management coverage of the same MME of the MMEs 224 and 225. In the operation described later, these two types of handover will be described. By these types of handover, the off-load GWs 226 to 228 are also changed that each receive the off-load traffic transmitted from the mobile terminal 261. In the example of FIG. 2, when the mobile terminal 261 changes the connection destination base stations 211 to 214 from the base station 211 to the base stations 212 to 214, the off-load GWs 226 to 228 are also changed from the off-load GW 226 to the off-load GWs 227 and 228.

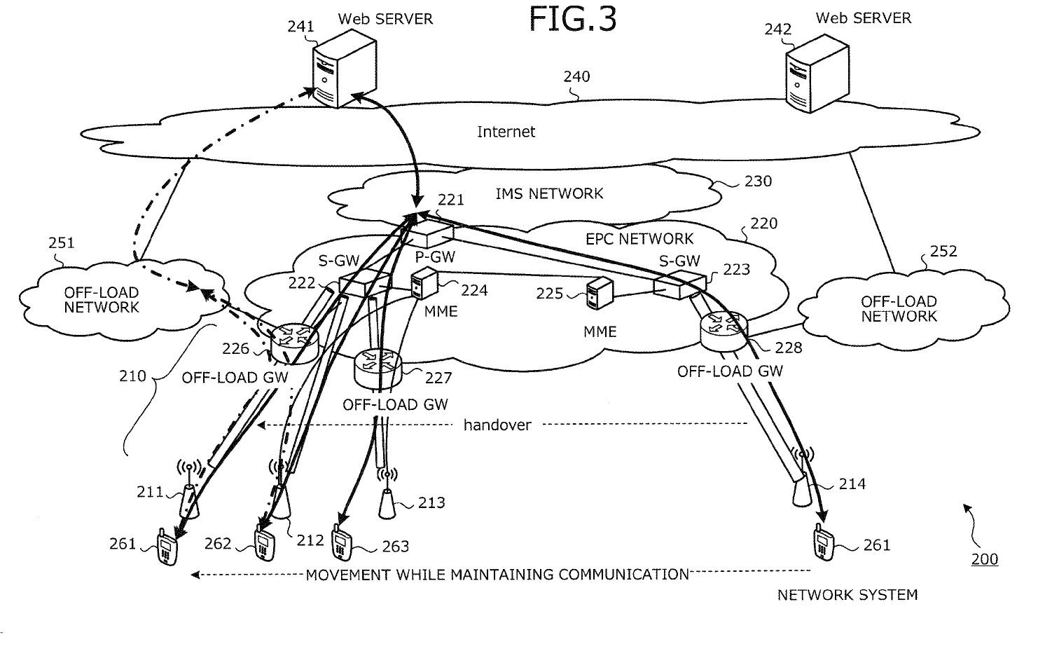

FIG. 3 is a diagram of an example of the communication quality with the handover. In FIG. 3, parts identical to those depicted in FIG. 2 will be given the same reference numerals used in FIG. 2 and will not again be described. In the example depicted in FIG. 3, the mobile terminal 261 is connected to the base station 214. Mobile stations 262 and 263 depicted in FIG. 3 are mobile terminals each different from the mobile terminal 261. The mobile terminals 262 and 263 are respectively connected to the base stations 212 and 213.

The off-load GW 226 detours a new session of each of the mobile terminals 262 and 263 to the second route to ensure the quality of experience (QoE) of the traffic of each of the mobile terminals 262 and 263 that passes through the first route.

The first route is a route connected to, for example, the ISP network 240 through the EPC network 220. The second route is a route connected to the ISP network 240 that does not pass through the EPC network 220 by passing through either of the off-load networks 251 and 252.

On the other hand, for the off-load GW 228, the first route is available and therefore, the overall traffic of the mobile terminal 261 passes through the first route. It is assumed in this state that the mobile terminal 261 executes a handover to the base station 211 under the off-load GW 226. In this case, the route of the traffic of the mobile terminal 261 is also the first route at the off-load GW 226 and therefore, the QoE may not be ensured of the traffic of each of the mobile terminals 262 and 263 and the traffic of the mobile terminal 261 passing through the first route of the off-load GW 226.

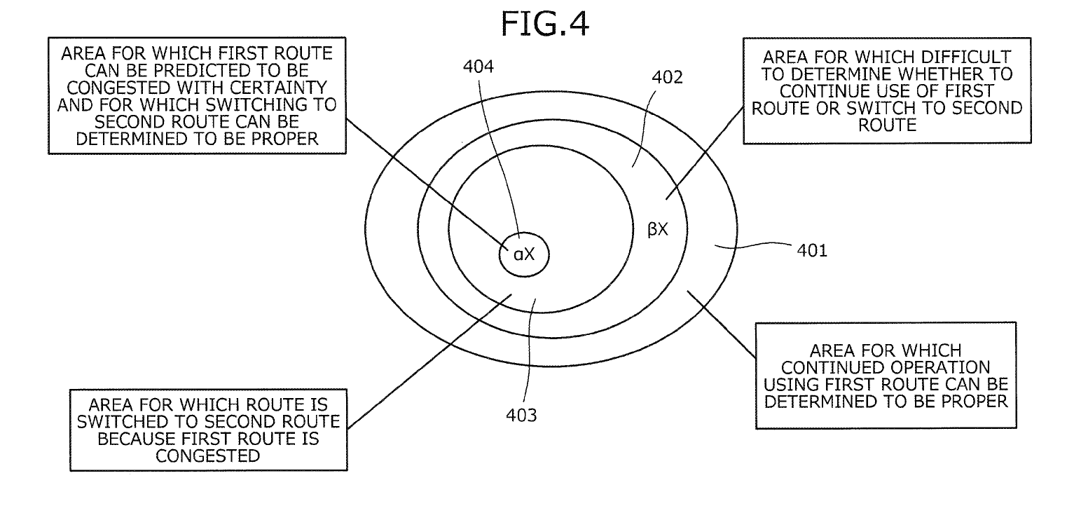

FIG. 4 is a diagram of an example of the determination of the route switching based on the geographical position relation. FIG. 4 depicts the determination of the route switching based on the location position (geographical position relation) of a mobile terminal such as the mobile terminal 261. An area 401 is an area for which it can be determined that it is proper to continue the operation using the first route as it is. An area 402 (βX) is an area for which it is difficult to determine which is better to continuously use the first route or to switch the route to the second route. An area 403 is an area for which the route is switched to the second route because the first route is congested. An area 404 (αX) is an area for which it can be estimated that the first route is surely congested and it can be determined that it is proper to switch the route to the second route.

For example, when the mobile terminal 261 in the area 402 using the first route moves into the area 403, the traffic of the first route in the area 403 is increased by the handover. As depicted in FIG. 4, in the mobile network, the congestion state of the neighboring apparatuses spreads around due to the handover. Therefore, depending on the geographical position relation, many apparatuses are involved in the route switching taking into consideration the influence associated with the move of the mobile terminal 261.

A configuration of the off-load GW will be described.

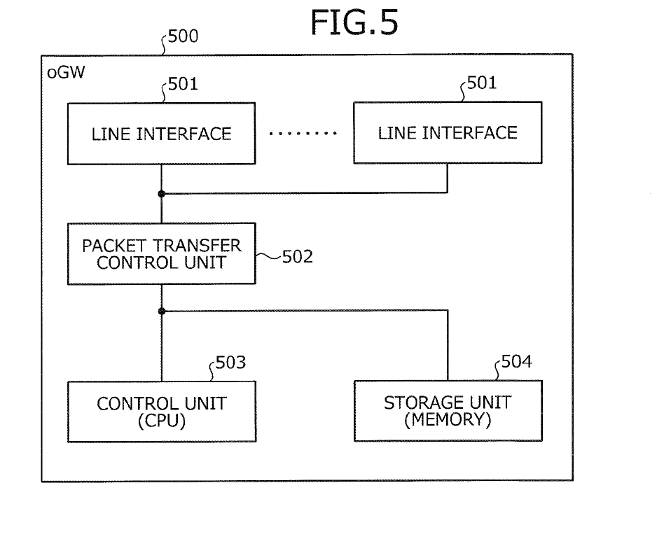

FIG. 5 is a diagram of an example of a hardware configuration of the off-load GW. Each of the off-load GWs 226 to 228 can be implemented by, for example, an off-load GW 500 (oGW) depicted in FIG. 5.

The off-load GW 500 includes a line interface 501, a packet transfer control unit 502, a central processing unit (CPU) 503, and a storage unit 504 (memory). The acquiring unit 131 and the selecting unit 132 depicted in FIG. 1 can be implemented by, for example, the line interface 501, the packet transfer control unit 502, and the CPU 503.

The line interface 501 accommodates, for example, lines connecting the off-load GWs 226 to 228 and the base stations 211 to 214 to each other, and the off-load GWs 226 to 228 and the S-GWs 222 and 223 to each other; and also accommodates, for example, the lines connecting the off-load GWs 226 to 228 and the MMEs 224 and 225 to each other, and the off-load GWs 226 to 228 and the off-load networks 251 and 252 to each other.

The off-load GWs 226 to 228 each includes one or more line interface(s) 501 corresponding to the number of lines accommodated. The line interface 501 is formed by, for example, a multi-purpose or a dedicated semiconductor circuit. For example, a large-scale integration (LSI), an application specific integrated circuit (ASIC), etc. can be used as the semiconductor circuit applied to the line interface 501.

The packet transfer control unit 502 is connected to the line interface 501, the CPU 503, and the storage unit 504; executes a packet transfer process; has therein, for example, a routing table; searches the routing table for an output port corresponding to a destination address of the packet; and outputs the packet to the output port.

The packet transfer control unit 502 can be formed as, for example, a circuit chip having a multi-purpose or a dedicated semiconductor circuit mounted thereon. For example, an LSI, an ASIC, a programmable logic device (PLD), or a digital signal processor (DSP) can be used as the semiconductor circuit applied to the packet transfer control unit 502.

For example, the CPU 503 controls the operations of the overall off-load GWs 226 to 228 through the control of the packet transfer control unit 502; is an example of a controller (control unit); and also an example of a processor. The controller supervising the functions of the CPU 503 is implemented by, for example, application of a dedicated or a multi-purpose hardware chip.

The storage unit 504 is formed by, for example, semiconductor memory such as a read only memory (ROM), a random access memory (RAM), or electrically erasable programmable ROM (EEPROM); and provides a working area for the CPU 503, storage areas for various programs executed by the CPU 503, etc.

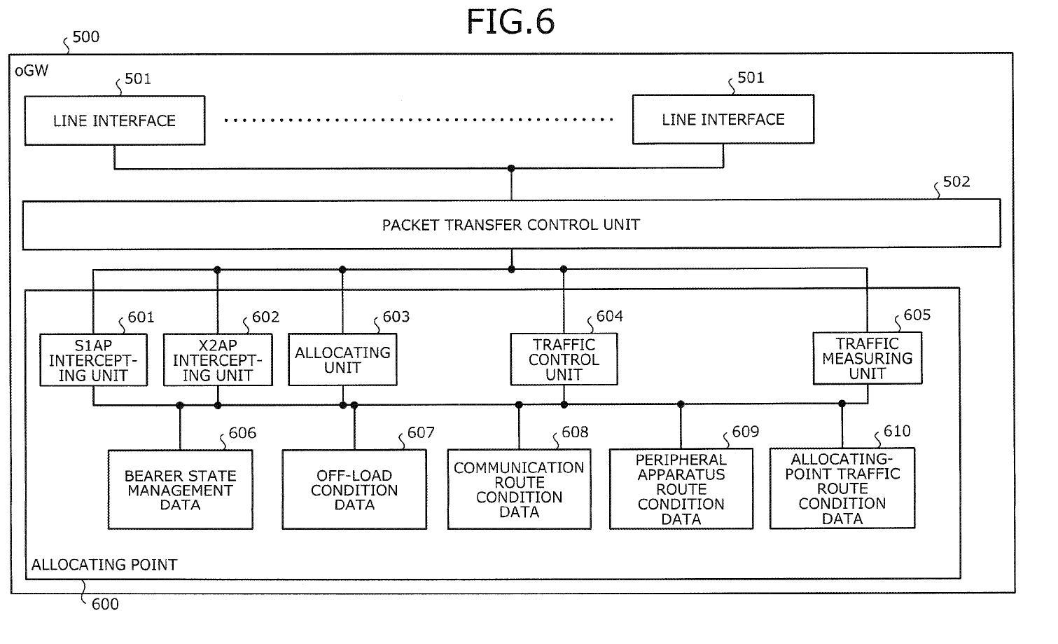

FIG. 6 is a diagram of an example of a functional configuration of the off-load GW. Functional blocks of the off-load GW 500 (oGW) depicted in FIG. 6 are functions implemented by, for example, by executing on the CPU 503, programs stored in the storage unit 504. The functional blocks depicted in FIG. 6 may be included in the off-load GW 500 as hardware.

The CPU 503 depicted in FIG. 5 functions as, for example, an allocating point 600. The allocating point 600 includes an S1AP intercepting unit 601, an X2AP intercepting unit 602, an allocating unit 603, a traffic control unit 604, a traffic measuring unit 605, bearer state management data 606, off-load condition data 607, communication route condition data 608, peripheral apparatus route condition data 609, and allocating-point traffic route condition data 610.

The storage unit 504 depicted in FIG. 5 stores the bearer state management data 606, the off-load condition data 607, the communication route condition data 608, the peripheral apparatus route condition data 609, and the allocating-point traffic route condition data 610.

The acquiring unit 131 depicted in FIG. 1 can be implemented by, for example, the line interface 501, the packet transfer control unit 502, the S1AP intercepting unit 601, and the X2AP intercepting unit 602. The selecting unit 132 depicted in FIG. 1 can be implemented by, for example, the line interface 501, the packet transfer control unit 502, the allocating unit 603, the traffic control unit 604, and the traffic measuring unit 605.

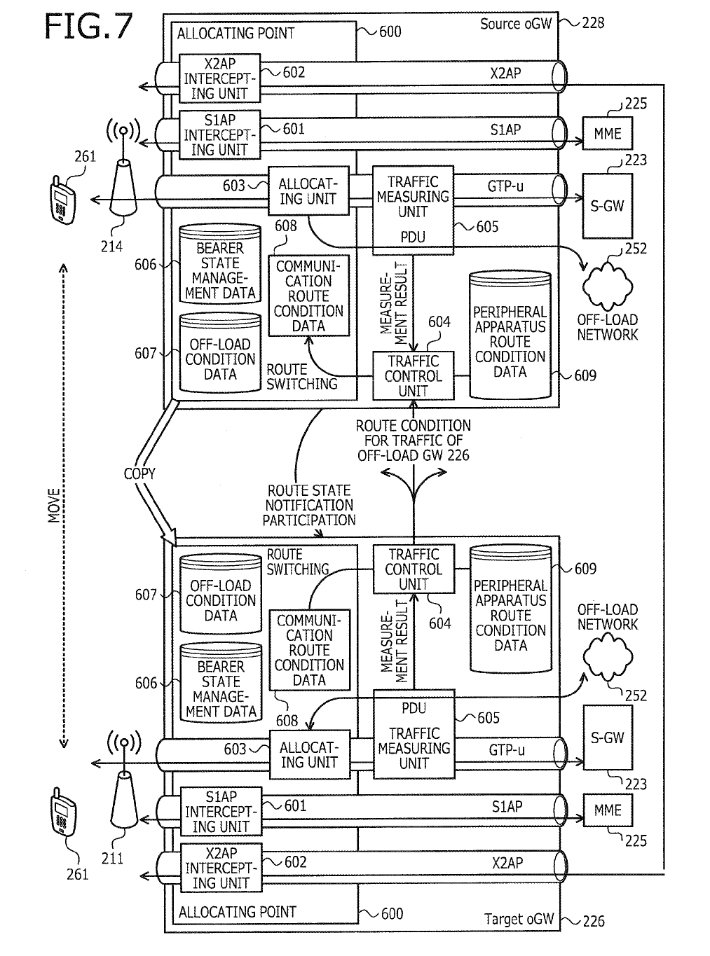

FIG. 7 is a diagram (Part I) of an example of operations executed by the units of the off-load GW. In the example depicted in FIG. 7, a case will be described where the mobile terminal 261 executes a handover from the base station 214 to the base station 211 (see, e.g., FIG. 3). In this case, the base station 214 is a source base station that is the handover source and the base station 211 is a target base station that is the handover destination.

The off-load GW accommodating the line of the mobile terminal 261 is changed from the off-load GW 228 to the off-load GW 226 associated with the handover. In this case, the off-load GW 228 is a source off-load GW (source oGW) that is the handover source and the off-load GW 226 is a target off-load GW (target oGW) that is the handover destination. The configuration of each of the off-load GWs 228 and 226 is same as that of the off-load GW 500 depicted in FIGS. 5 and 6.

The S1AP intercepting unit 601 of the off-load GW 228 intercept a control packet based on the S1 application protocol (S1AP) between the base station 214 and the MME 225. In the example depicted in FIG. 7, the S1AP intercepting unit 601 of the off-load GW 228 detects the triggers for allocation and a handover of the communication line for the mobile terminal 261 for the handover.

The S1AP is, for example, a protocol for the C-plane that provides a signaling service between the base stations 211 to 214 (evolved universal terrestrial radio access network: eUTRAN) and the MMES 224 and 225. Based on the S1AP, the base stations 211 to 214 and the MMEs 224 and 225 can execute, for example establishment, a change, and release of a bearer; handover control; and incoming call control for a mobile terminal in the stand-by mode.

The X2AP intercepting unit 602 of the off-load GW 228 intercepts, for example, a control packet based on the X2 application protocol (X2AP) transmitted and received between the base stations 211 to 214. In the example depicted in FIG. 7, the X2AP intercepting unit 602 of the off-load GW 228 detects the triggers for allocation and a handover of the communication line for the target mobile terminal 261.

The X2AP is, for example, a protocol in the C-plane among the base stations 211 to 214 on the X2 interface. Based on the X2AP, the base stations 211 to 214 can execute the load management among the base stations, the handover control, etc.

As described, the off-load GW 228 to be the handover source intercepts the S1AP and the X2AP and thereby, identifies the base station 211 to be the handover destination and the off-load GW 226.

For example, the allocating unit 603 of the off-load GW 228 extracts from a communication line, data transmitted to the web servers 241 and 242 using the communication line according to the allocation of the communication line of the target mobile terminal 261; and transmits the extracted data to the off-load network 252. Thereby, the allocating unit 603 of the off-load GW 228 can branch the off-load traffic to the off-load network 252. In this case, the allocating unit 603 of the off-load GW 228 can branch the traffic that matches the off-load application condition.

In the example of FIG. 7, the traffic transmitted from the mobile terminal 261 flows in a GPRS tunneling protocol for user plane (GTP-u) tunnel. The “GTP-u” is a protocol for, for example, IP transmission between the base stations 211 to 214 and the S-GWs 222 and 223. Not only the traffic for the uplink communication but also the traffic for the downlink communication flow in a bearer (the GTP-u tunnel) established between the base stations 211 to 214 and the S-GWs 222 and 223.

When the mobile terminal 261 executes the handover from the base station 214 to the base station 211, the off-load condition data 607 for the mobile terminal 261 is copied from the off-load GW 228 to the off-load GW 226. The off-load GW 226 controls the route for the session of the mobile terminal 261 based on the copied off-load condition data 607.

The off-load GW 226 multicast-distributes the route condition for the traffic thereof loading the condition on the route condition packet. Though the off-load GW 228 also multicasts the route condition for the traffic thereof loading the condition on the route condition packet, this distribution is not depicted in FIG. 7.

The traffic control unit 604 of the off-load GW 228 participates in the reception of the multicast-distribution by the off-load GW 226; receives the route condition for the traffic of the off-load GW 226 multicast-distributed from the off-load GW 226; stores therein the received route condition for the traffic of the off-load GW 226 as the peripheral apparatus route condition data 609; and controls the route of the session of the mobile terminal 261 based on the peripheral apparatus route condition data 609.

Thereby, for example, when the off-load GW 226 selects the second route, the traffic control unit 604 of the off-load GW 228 switches the route of the mobile terminal 261 to the second route. Thereby, when the mobile terminal 261 executes the handover from the base station 214 to the base station 211, the congestion can be suppressed of the first route at the off-load GW 226.

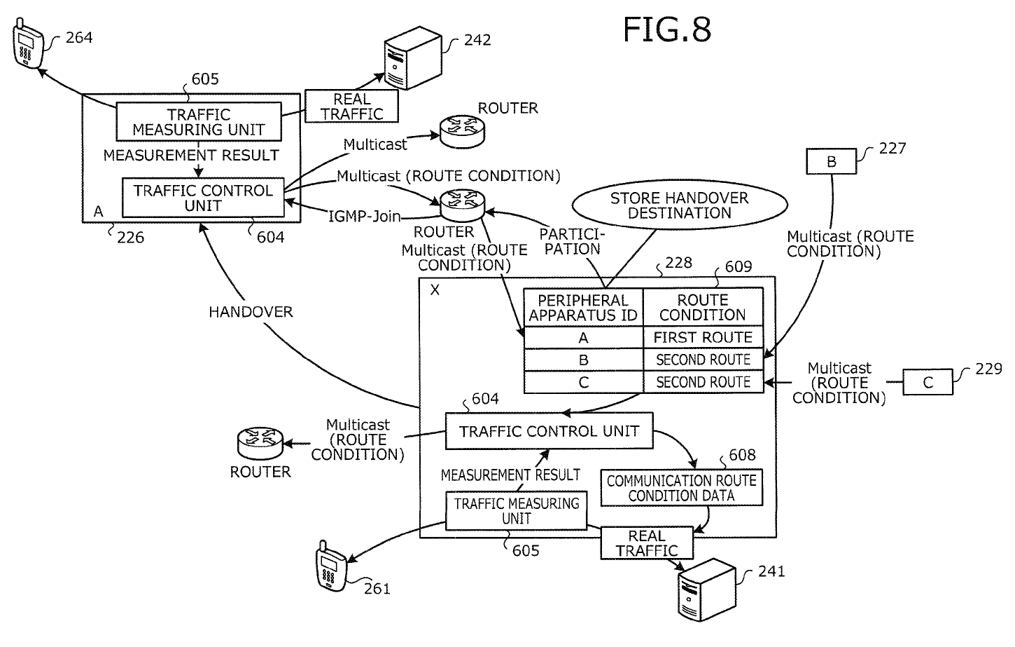

FIG. 8 is a diagram (Part II) of an example of operations executed by the units of the off-load GW. In FIG. 8, parts identical to those depicted in FIG. 7 will be given the same reference numerals used in FIG. 7 and will not again be described. In FIG. 8, similar to FIG. 7, a case will also be described where the mobile terminal 261 executes the handover from the base station 214 to the base station 211 (see, e.g., FIG. 3). The mobile terminal 264 is a mobile terminal connected to the base station 211.

In the example depicted in FIG. 8, the peripheral apparatus route condition data 609 stored in the off-load GW 228 includes the route condition for the traffic of each of the off-load GWs 226, 227, and 229. The peripheral apparatus IDs of the peripheral apparatus route condition data 609 indicate the off-load GWs 226, 227, and 229. In the example of FIG. 8, the off-load GW 226 (A) selects the first route and the off-load GWs 227 and 229 (B and C) select the second route.

The off-load GW 228 selects the route of the mobile terminal 261 based on the peripheral apparatus route condition data 609. For example, because the off-load GWs 227 and 229 to be the handover targets of the mobile terminal 261 select the second route, the off-load GW 228 determines that the route for the mobile terminal 261 is the second route. Thereby, for example, even when the mobile terminal 261 executes the handover to the base station under the off-load GWs 227 and 229, the congestion of the first route at the handover destination can be suppressed.

A data structure at each off-load GW will be described.

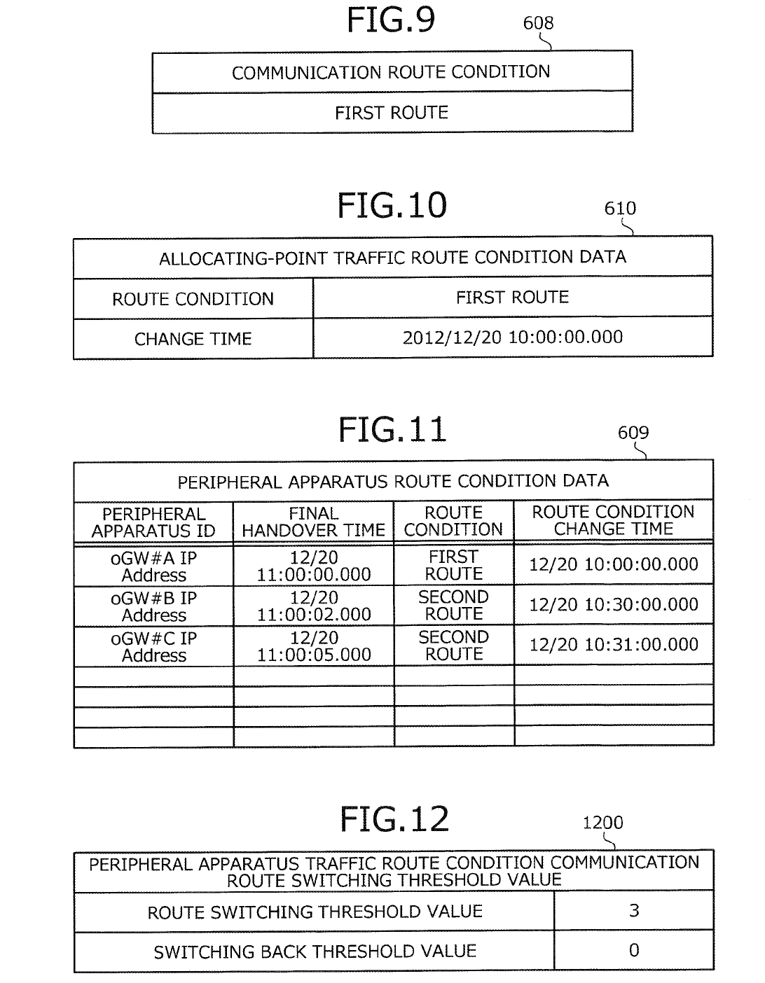

FIG. 9 is a diagram of an example of the communication route condition data. The off-load GW 500 stores in the storage unit 504, for example, the communication route condition data 608 depicted in FIG. 9. As depicted in FIG. 9, the communication route condition data 608 indicates the communication route to cause the new session to pass therethrough (“communication route condition”). For example, the communication route condition data 608 indicates either of the first and the second routes. The first route is a route passing through the EPC network 220, and the second route is a route passing through the off-load network connected to the off-load GW 500 of the off-load networks 251 and 252.

In the example depicted in FIG. 9, the communication route condition data 608 indicates the first route. Therefore, when a new session occurs, the off-load GW 500 causes the occurring new session to pass through the first route.

FIG. 10 is a diagram of an example of the allocating-point traffic route condition data. The off-load GW 500 stores in the storage unit 504, for example, the allocating-point traffic route condition data 610 depicted in FIG. 10. As depicted in FIG. 10, the allocating-point traffic route condition data 610 includes a “route condition” and a “change time”. The “route condition” indicates a route to cause the new session to pass therethrough, and is determined based on the measurement result of the traffic at the off-load GW 500. For example, the “route condition” indicates any one among the first and the second routes. The “change time” represents the time at which the “route condition” is updated.

The off-load GW 500 multicast-distributes the allocating-point traffic route condition data 610 to surrounding other off-load GWs 500.

FIG. 11 is a diagram of an example of the peripheral apparatus route condition data. The off-load GW 500 has, for example, the peripheral apparatus route condition data 609 depicted in FIG. 11 stored in the storage unit 504. As depicted in FIG. 11, the peripheral apparatus route condition data 609 includes a “peripheral apparatus ID”, a “final handover time”, a “route condition”, and a “route condition change time”.

The “peripheral apparatus ID” represents the ID of a surrounding off-load GW (the distribution source off-load GW of the “route condition”). The “final handover time” represents the latest time at which the handover is executed to the off-load GW represented by the “peripheral apparatus ID”.

The “route condition” represents the latest route condition notified from the off-load GW represented by the “peripheral apparatus ID”. The “route condition change time” represents the latest route condition change time notified from the off-load GW represented by the “peripheral apparatus ID”. The “route condition” and the “route condition change time” are information based on the allocating-point traffic route condition data 610 that is multicast-distributed from the other off-load GW 500.

FIG. 12 is a diagram of an example of a peripheral apparatus traffic route condition communication route switching threshold value. The off-load GW 500 has, for example, the peripheral apparatus traffic route condition communication route switching threshold value 1200 depicted in FIG. 12 stored in the storage unit 504. The peripheral apparatus traffic route condition communication route switching threshold value 1200 includes a “route switching threshold value” and a “switching back threshold value”.

The “route switching threshold value” and the “switching back threshold value” of the peripheral apparatus traffic route condition communication route switching threshold value 1200 each represent a threshold value to be compared to the number (or the rate) of peripheral apparatus traffic route condition(s).

For example, when the number of peripheral apparatus traffic route conditions exceeds the “route switching threshold value”, the “communication route condition” of the communication route condition data 608 is switched to the bypass (the second route). When the number (or the rate) of peripheral apparatus traffic route conditions is lower than the “switching back threshold value”, the “communication route condition” of the communication route condition data 608 is switched to a normal route (the first route).

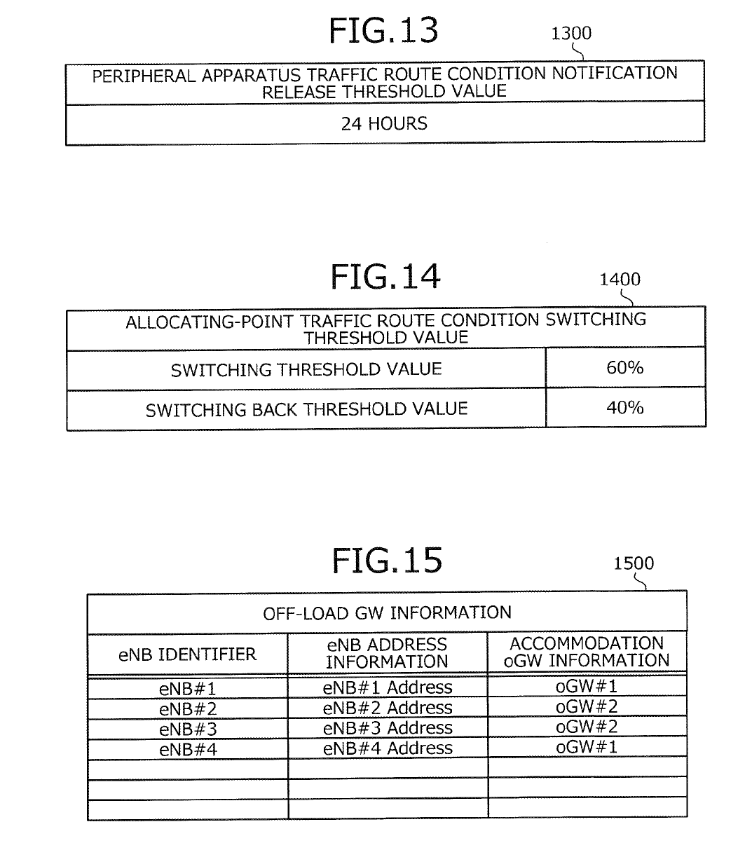

FIG. 13 is a diagram of an example of a peripheral apparatus traffic route condition notification release threshold value. The off-load GW 500 has, for example, the peripheral apparatus traffic route condition notification release threshold value 1300 depicted in FIG. 13 stored in the storage unit 504. The peripheral apparatus traffic route condition notification release threshold value 1300 is a threshold value to discontinue the reception of a route condition notification packet from the handover destination off-load GW when the time period elapsing from the final handover time exceeds this threshold value.

FIG. 14 is a diagram of an example of an allocating-point traffic route condition switching threshold value. An allocating-point traffic route condition switching threshold value 1400 depicted in FIG. 14 is an allocating-point traffic route condition switching threshold value stored in the off-load GW 1500 and includes the “switching threshold value” and the “switching back threshold value”. The “switching threshold value” and the “switching back threshold value” of the allocating-point traffic route condition switching threshold value 1400 each represents a threshold value to be compared to the traffic measurement value of the normal route (the first route).

For example, when the traffic measurement value of the normal route (the first route) exceeds the “switching threshold value”, the “route condition” of the allocating-point traffic route condition data 610 is switched to the bypass (the second route). When the traffic measurement value of the normal route (the first route) is lower than the “switching back threshold value”, the “route condition” of the allocating-point traffic route condition data 610 is switched to the normal route (the first route).

FIG. 15 is a diagram of an example of off-load GW information on the off-load GW accommodating the eNB. The off-load GW 500 has, for example, the off-load GW information 1500 (eNB accommodation table) depicted in FIG. 15 stored in the storage unit 504. The off-load GW information 1500 is information indicating the off-load GW that accommodates the base stations 211 to 214.

The off-load GW information 1500 includes an “eNB identifier”, “eNB address information”, and accommodation oGW information. The “eNB identifier” is the identifier of the base station, and eNBs #1 to #4 respectively represents the base stations 211 to 214. The “eNB address information” indicates the address of the base station represented by the “eNB identifier”. “Accommodating oGW information” indicates the off-load GW accommodating the base station represented by the “eNB identifier”. The oGWs #1 and #2 of the “accommodating oGW information” respectively represents, for example, the off-load GWs 226 and 228.

The off-load GW 500 refers to the off-load GW information 1500 and can search for the off-load GW that accommodates the base stations 211 to 214. The off-load GW information 1500 is used to, for example, identify the off-load GW to act as the allocating point due to the handover of the mobile terminal 261 from the off-load GWs 226 to 228.

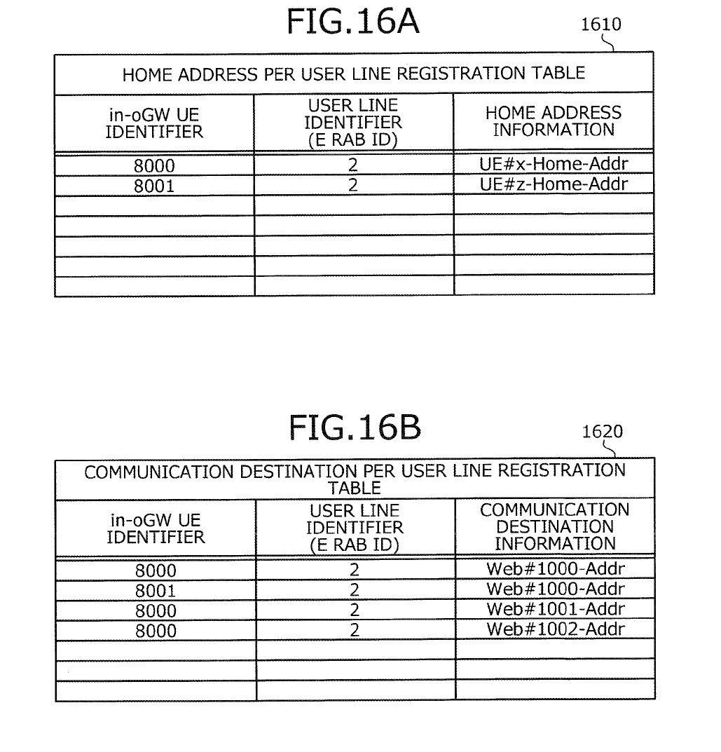

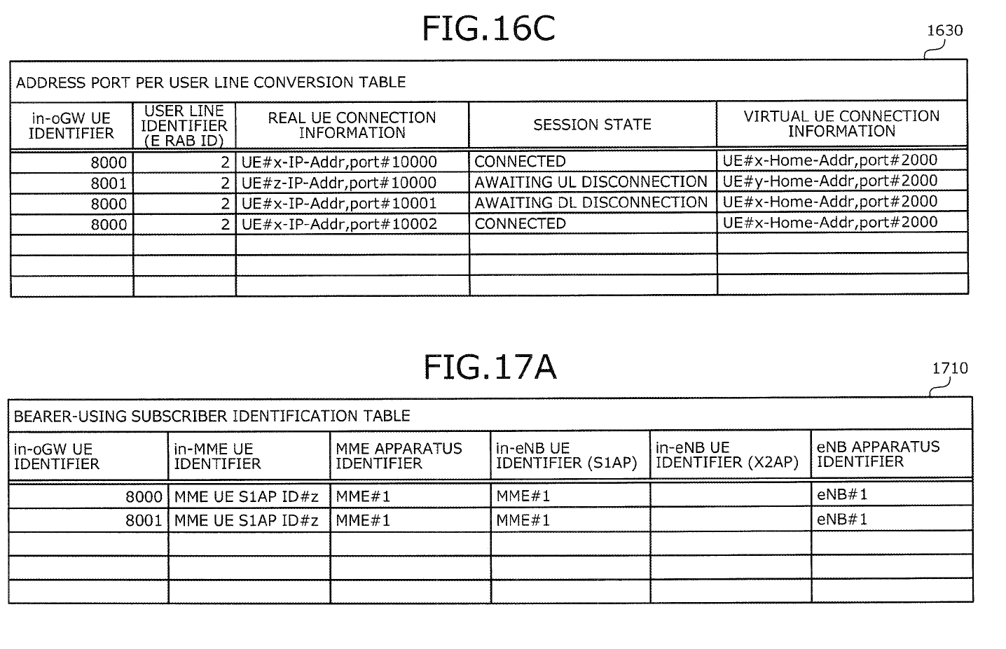

FIGS. 16A, 16B, and 16C are diagrams of an example of the off-load condition data. The off-load condition data 607 includes, for example, a home address per user line registration table 1610 depicted in FIG. 16A, a communication destination per user line registration table 1620 depicted in FIG. 16B, and an address port per user line conversion table 1630 depicted in FIG. 16C. The off-load GW 500 transmits, for example, the off-load packets to the off-load networks 251 and 252 based on the off-load condition data 607.

The home address per user line registration table 1610 depicted in FIG. 16A includes an “in-oGW UE identifier”, a “user line identifier”, and “home address information”. The “in-oGW UE identifier” represents, for example, information to uniquely identify the mobile terminal accommodated by the off-load GW 500.

The “user line identifier” represents information to uniquely identify the user line in the mobile terminal, and is synchronized with an E-UTRAN radio access bearer (E-RAB) ID that is a line identifier in the mobile terminal. The “home address information” indicates the home address of the mobile terminal.

The off-load GW 500 can correlate the “home address information”, the “in-oGW UE identifier”, and the “user line identifier” with each other based on the home address per user line registration table 1610. For the home address stored in the “home address information”, the same value is maintained as the home address of a virtual UE until the corresponding user line is disconnected.

The communication destination per user line registration table 1620 depicted in FIG. 16B includes an item of “communication destination information”. The “communication destination information” indicates, for example, the addresses of the communication destinations of the mobile terminal 261 (for example, the addresses of the web servers 241 and 242). The off-load GW 500 can correlate the address of the communication destination of the mobile terminal, the “in-oGW UE identifier”, and the “user line identifier” with each other based on the communication destination per user line registration table 1620.

The address port per user line conversion table 1630 depicted in FIG. 16C includes items of “real UE connection information”, the “session state”, and “virtual UE connection information”. The “real UE connection information” indicates, for example, connection information on the TCP communication of the off-load target, among the communication between the real UE (or the mobile terminal 261) and the communication counterparts (or the web servers 241 and 242). The “real UE” is, for example, a mobile terminal identified based on the IP address paid out by the P-GW 221. The “real UE connection information” includes the identifier of the mobile terminal, the IP address, and the TCP port number in the example of FIG. 16C.

The “session state” represents, for example, the state of the corresponding communication line. Types of the state of the communication line includes, for example, “currently connected”, “standing by for UL disconnection”, and “standing by for DL disconnection”. The “virtual UE connection information” indicates the TCP connection information on the virtual UE. The virtual UE means, for example, a mobile terminal identified by the home address. In the example of FIG. 16C, the “virtual UE connection information” includes the identifier, the home address, and the TCP port number of the mobile terminal.

Based on the address port per user line conversion table 1630, the off-load GW 500 can grasp the mutual state of the TCP connection information on the real UE and that of the virtual UE, and the connection information is correlated with the “in-oGW UE identifier” and the “user line identifier”.

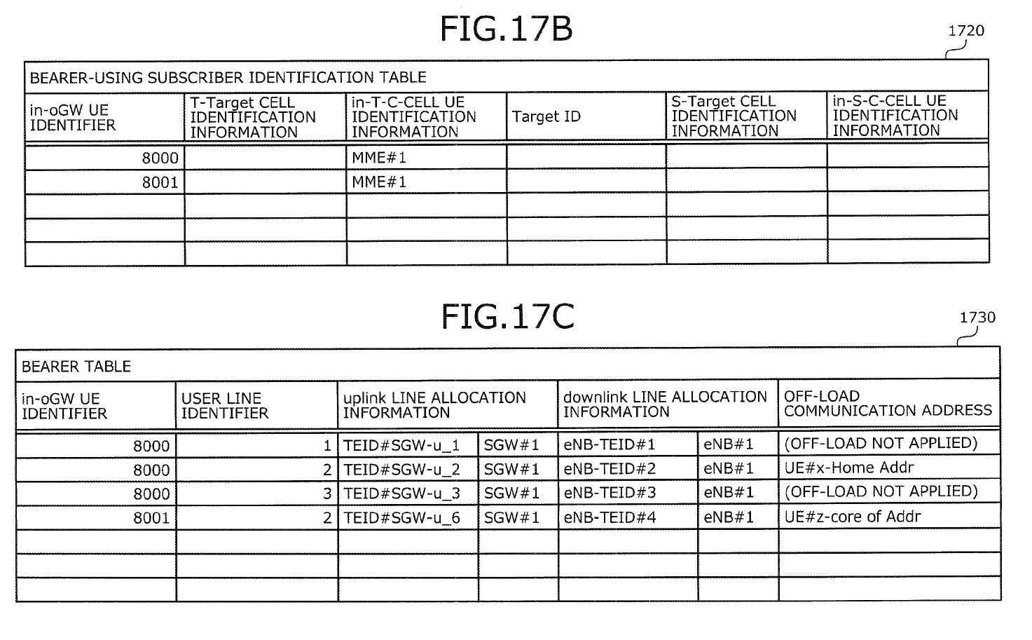

FIGS. 17A, 17B, and 17C are diagrams of an example of a bearer-using subscriber identification table. The bearer state management data 606 includes, for example, the bearer-using subscriber identification tables 1710 and 1720 respectively depicted in FIGS. 17A and 17B and a bearer table 1730 depicted in FIG. 17C. The bearer-using subscriber identification tables 1710 and 1720 respectively depicted in FIGS. 17A and 17B are a series of tables. The “in-oGW UE identifier” of the bearer-using subscriber identification table 1720 has the same value as that of the “in-oGW UE identifier” of the bearer-using subscriber identification table 1710 and is described to clearly represent that these items are same records.

The “in-oGW UE identifier” represents information for the off-load GW 500 to uniquely identify the mobile terminal. The “MME apparatus identifier” represents, for example, the identifier of the MME that supplies “in-oGW UE identifier” of the MMEs 224 and 225, to the mobile terminal. The “in-eNB UE identifier (S1AP)” represents, for example, the identifier of the mobile terminal supplied by the base stations 211 to 214 (an eNB UE S1AP ID). The “in-eNB UE identifier (X2AP)” represents, for example, the identifier of the mobile terminal supplied by the base stations 211 to 214 (an eNB UE X2AP ID). The “eNB apparatus identifier” represents, for example, the identifier of the base station that supplies the “in-eNB UE identifier (S1AP)” and the “in-eNB UE identifier (X2AP)” to the mobile terminal, of the base stations 211 to 214.

“T-target cell identification information” indicates, for example, handover destination cell identification information selected by the handover source base station received by the handover destination off-load GW 500 of the off-load GWs 226 to 228.

“In-T-C-cell UE identification information” is, for example, the identification information of the mobile terminal received by the handover destination off-load GW 500, and indicates identification information of the mobile terminal in the handover destination cell selected by the handover destination base station.

“Target ID” is, for example, identification information of the mobile terminal received by the handover source off-load GW 500 and represents the identification information of the mobile terminal in the handover destination cell selected by the handover source base station.

“S-target cell identification information” indicates the cell identification information of the handover destination selected by the handover source base station received by the handover source off-load GW 500. “In-S-C-cell UE identification information” indicates the UE identification information at the handover destination cell selected by the handover destination base station received by the handover source off-load GW 500.

The bearer table 1730 depicted in FIG. 17C includes an “in-oGW UE identifier”, the “user line identifier”, “uplink line allocation information”, “downlink line allocation information”, and the “off-load communication address”.

The “in-oGW UE identifier” represents information for the off-load GW 500 to uniquely identify the mobile terminal. For the same one mobile terminal, the “in-oGW UE identifier” of the bearer table 1730 and that of the bearer-using subscriber identification table 1710 represent the same one identifier. The “user line identifier” has information stored therein to uniquely identify the user line in the mobile terminal, and is synchronized with the line identifier (E RAB ID) in the mobile terminal.

The “uplink line allocation information” indicates, for example, address information of an uplink packet traveling toward the S-GWs 222 and 223 for the user line identifier. The “downlink line allocation information” indicates, for example, address information of a downlink packet traveling toward the base stations 211 and 214 for the user line identifier.

The “off-load communication address” represents, for example, an address to transmit and receive the packets through the off-load networks 251 and 252 corresponding to the virtual UE. The “off-load communication address” is, for example, also an address available for transmission and reception in a link accommodated in the off-load GW 500. In the example of FIG. 17C, the home address or a care-of address is stored together with the identifier of the corresponding mobile terminal.

The data transmitted and received in the network system 200 will be described.

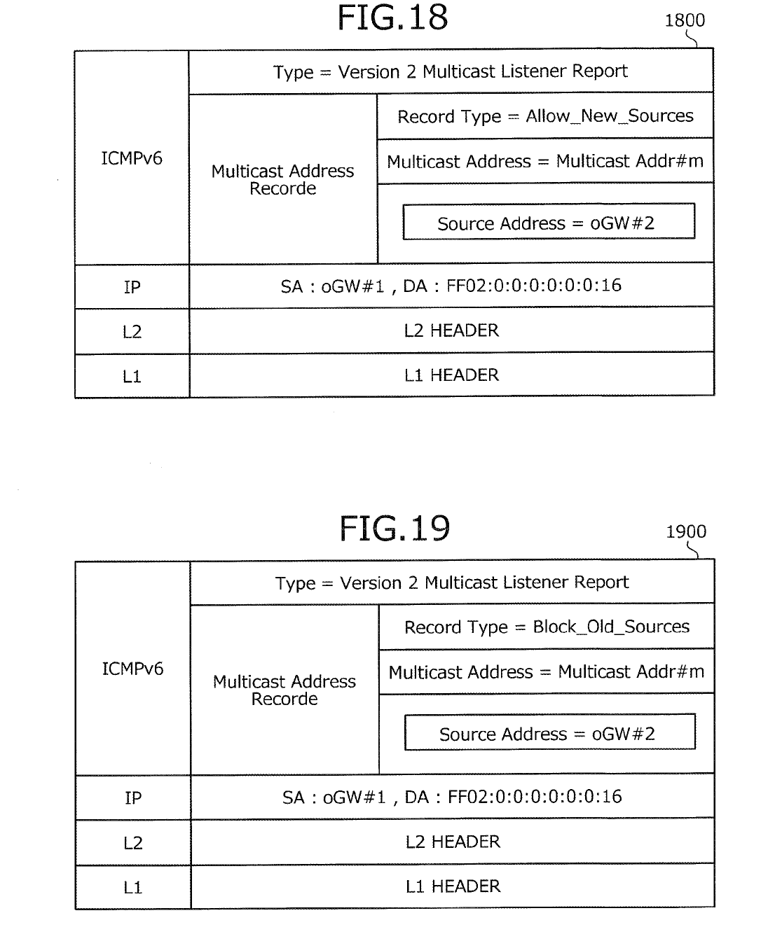

FIG. 18 is a diagram of an example of a route state notification reception participation packet. The off-load GW 500 transmits, for example, the route state notification reception participation packet 1800 depicted in FIG. 18.

FIG. 19 is a diagram of an example of a route state notification reception participation packet. The off-load GW 500 transmits, for example, the route state notification reception participation packet 1900 depicted in FIG. 19.

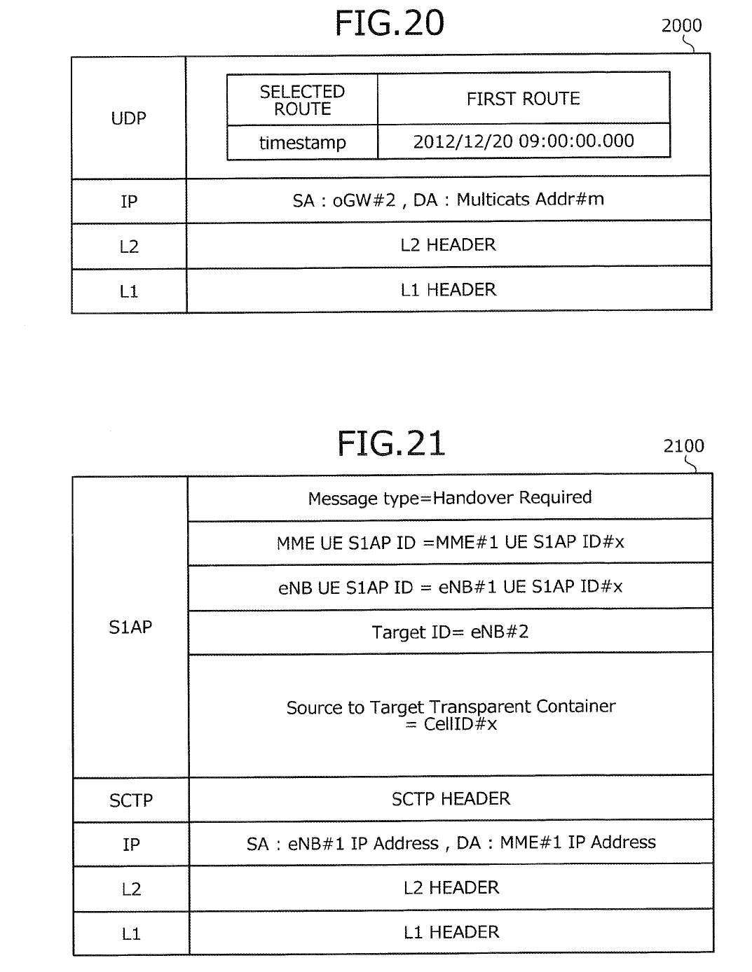

FIG. 20 is a diagram of an example of a route state notification packet. The off-load GW 500 transmits, for example, a route state notification packet 2000 depicted in FIG. 20.

FIG. 21 is a diagram of an example of “Handover Required”. For example, the “Handover Required” 2100 depicted in FIG. 21 is transmitted from the mobile terminal 261 to the MME 225 (a source MME) when the mobile terminal 261 executes the S1-based handover from the base station 214 to the base station 211.

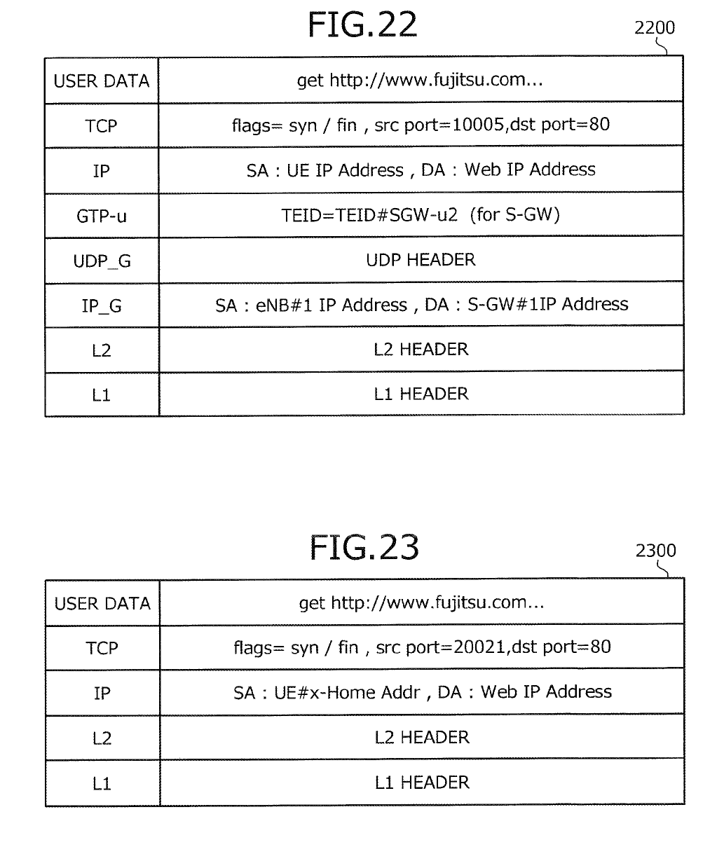

FIG. 22 is a diagram of an example of a GTP-u packet. The GTP-u packet 2200 of an uplink depicted in FIG. 22 is the GTP-u packet of the uplink from the base stations 211 to 214 to the S-GWs 222 and 223 (an uplink GTP-u packet). The GTP-u packet 2200 includes code data, a TCP header, an IP header, a GTP-u header, a UDP G header, an IP_G header, an L2 (a layer 2) header, and an L1 (a layer 1) header.

The GTP-u packet 2200 is a packet formed by encapsulating an IP packet that includes the code data, the TCP header, and the IP header using the GTP-u header, the UDP-_G header, and the IP_G header, and attaching the L2 and the L1 headers to the capsule.

In the example depicted in FIG. 22, the IP address of the web server 241 or 242 is set as the destination address of the IP packet of the GTP-u packet 2200, and the IP address of the mobile terminal 261 is set as the transmission source IP address. On the other hand, the directed IP address of the IP_G header is the IP addresses of the S-GW 222 and 223, and the transmission source IP address is the IP address of the base station 211. “TEID” is a value indicating the S-GW 222 located at the ending point of the GTP tunnel.

FIG. 23 is a diagram of an example of a packet from the off-load GW to the web server through the off-load network. The packet 2300 depicted in FIG. 23 is an off-load packet transmitted from the off-load GW 500 to the web servers 241 and 242 through the off-load networks 251 and 252. Compared to the GTP-u packet 2200 (FIG. 22), for the packet 2300, the transmission source IP address of the IP header is a care-of address and the home address is attached as a home address option.

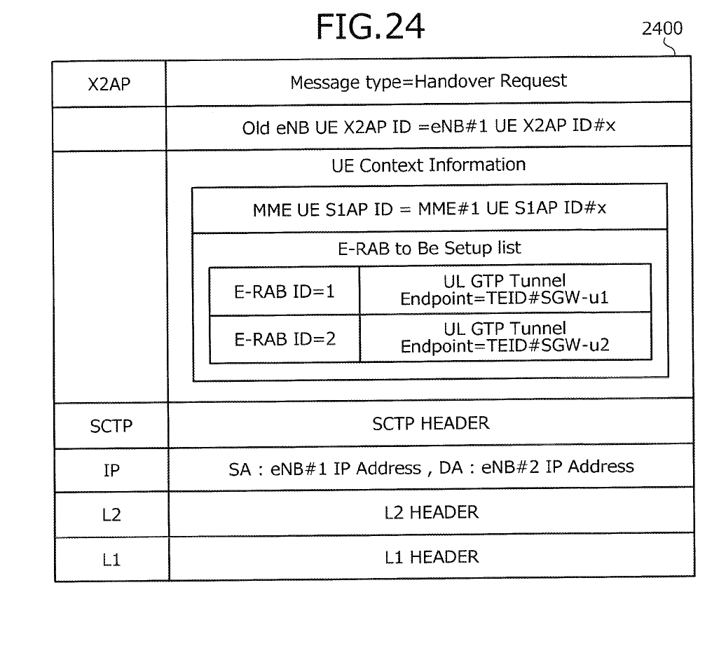

FIG. 24 is a diagram of an example of “Handover Request” based on the X2AP. In handover based on the X2AP, “Handover Request” 2400 depicted in FIG. 24 is “Handover Request” transferred from the handover source base station to the handover destination base station through the off-load GWs 226 to 228.

A procedure for a process executed by the off-load GWs will be described.

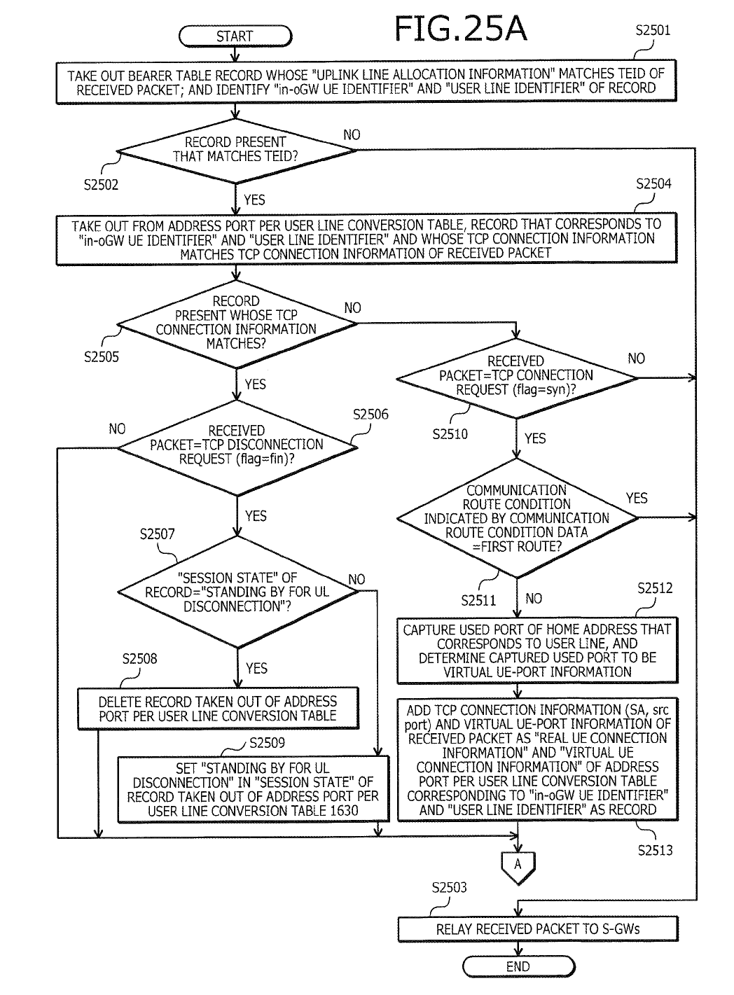

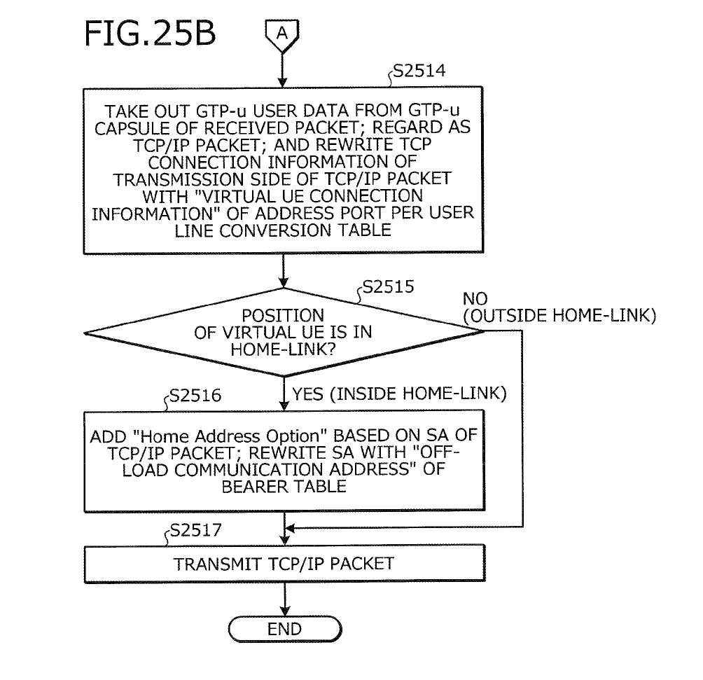

FIGS. 25A and 25B are a flowchart of an example of a process executed when the uplink GTP-u packet addressed to the S-GW is received. When the off-load GW 500 receives the uplink GTP-u packet 2200 addressed to the S-GWs 222 and 223 (hereinafter, referred to as “received packet”), the off-load GW 500 executes, for example, steps depicted in FIGS. 25A and 25B using the CPU 503.

The off-load GW 500 takes out a record of the bearer table 1730 whose “uplink line allocation information” of the bearer table 1730 matches the TEID of the received packet; and identifies the “in-oGW UE identifier” and the “user line identifier” of the record (step S2501).

The off-load GW 500 determines whether any record is present that matches the TEID at step S2501 (step S2502). If the off-load GW 500 determines that no such record is present (step S2502: NO), the off-load GW 500 relays the received packet to the S-GWs 222 and 223 (step S2503) and causes the series of process steps to come to an end.

If the off-load GW 500 determines at step S2502 that such a record is present (step S2502: YES), the off-load GW 500 progresses to the operation at step S2504. The off-load GW 500 takes out a predetermined record from the address port per user line conversion table 1630 (step S2504). The predetermined record is a record that corresponds to the “in-oGW UE identifier” and the “user line identifier” identified at step S2501, and whose TCP connection information matches the TCP connection information of the received packet. The TCP connection information is, for example, a source IP address (SA) and the source port number (src port).

The off-load GW 500 determines whether any record is present whose TCP connection information matches at step S2504 (step S2505). If the off-load GW 500 determines that a record is present whose TCP connection information matches at step S2504 (step S2505: YES), the off-load GW 500 determines whether the received packet is a TCP disconnection request (flag=fin) (step S2506).

If the off-load GW 500 determines at step S2506 that the received packet is not the TCP disconnection request (step S2506: NO), the off-load GW 500 progresses to the operation at step S2514. If the off-load GW 500 determines that the received packet is the TCP disconnection request (step S2506: YES), the off-load GW 500 determines whether the “session state” of the record taken out at step S2504 is “standing by for UL disconnection” (step S2507).

If the off-load GW 500 determines at step S2507 that the “session state” is “standing by for UL disconnection” (step S2507: YES), the off-load GW 500 deletes the record taken out of the address port per user line conversion table 1630 (step S2508) and progresses to the operation at step S2514. If the off-load GW 500 determines that the “session state” is not “standing by for UL disconnection” (step S2507: NO), the off-load GW 500 sets “standing by for UL disconnection” in the “session state” of the record taken out of the address port per user line conversion table 1630 (step S2509) and progresses to the operation at step S2514.

If the off-load GW 500 determines at step S2505 that no record is present whose TCP connection information matches at step S2504 (step S2505: NO), the off-load GW 500 determines whether the received packet is a TCP connection request (flag=syn) (step S2510).

If the off-load GW 500 determines at step S2510 that the received packet is not a TCP connection request (step S2510: NO), the off-load GW 500 progresses to the operation at step S2503. If the off-load GW 500 determines that the received packet is a TCP connection request (step S2510: YES), the off-load GW 500 determines whether the communication route condition indicated by the communication route condition data 608 is the first route (step S2511).

If the off-load GW 500 determines at step S2511 that the communication route condition is the first route (step S2511: YES), the off-load GW 500 progresses to the operation at step S2503. If the off-load GW 500 determines that the communication route condition is the second route (step S2511: NO), the off-load GW 500 captures a used port that corresponds to the user line, and determines the captured used port to be virtual UE-port information (step S2512).

The off-load GW 500 adds the TCP connection information (SA, src port) and the virtual UE-port information of the received packet to the record of the address port per user line conversion table 1630 (step S2513). For example, the off-load GW 500 adds the information as the “real UE connection information” and the “virtual UE connection information” of the address port per user line conversion table 1630 corresponding to the “in-oGW UE identifier” and the “user line identifier”.

Thereby, for example, the “real UE connection information” and the “virtual UE connection information” are added in the record corresponding to the “in-oGW UE identifier” and the “user line identifier” in the address port per user line conversion table 1630.

The off-load GW 500 takes out the GTP-u user data from the GTP-u capsule of the received packet; thereby, produces a TCP/IP packet; and rewrites the TCP connection information of the transmission side of the TCP/IP packet with the “virtual UE connection information” of the address port per user line conversion table 1630 (step S2514).

Thus, for example, the off-load GW 500 can change the TCP header and the IP header of the received packet based on the address port per user line conversion table 1630. For example, the off-load GW 500 rewrites the transmission source port number of the TCP header of the received packet from the port number corresponding to the real UE, to the port number corresponding to the virtual UE and, for example, rewrites the transmission source IP address of the IP header of the received packet from the IP address corresponding to the real UE (or the IP address of the mobile terminal 261), to the home address corresponding to the virtual UE.

The off-load GW 500 determines whether the position of the virtual UE is in a home-link (step S2515). For example, the off-load GW 500 acquires the “home address information” of the home address per user line registration table 1610; acquires the “off-load communication address” of the bearer table 1730 corresponding to the “in-oGW UE identifier” and the “user line identifier” of the acquired “home address information”; and compares the acquired “home address information” and the “off-load communication address” with each other. For example, when the two addresses match each other, the off-load GW 500 can determine that the virtual UE is in the home-link and when the two addresses do not match each other, the off-load GW 500 can determine that the virtual UE is not in the home-link.

If the off-load GW 500 determines at step S2515 that the position of the virtual EU is not in the home-link (step S2515: NO), the information such as the home address is transmitted from the off-load GW 226 to the off-load GW 228. In this case, the off-load GW 500 progresses to the operation at step S2517.

If the off-load GW 500 determines at step S2515 that the position of the virtual UE is in the home-link (step S2515: YES), the off-load GW 500 progresses to the operation at step S2516. The off-load GW 500 adds “Home Address Option” based on the SA of the TCP/IP packet; rewrites the SA with the “off-load communication address” of the bearer table 1730 (step S2516); transmits the TCP/IP packet to the off-load network connected to the off-load GW 500 of the off-load networks 251 and 252 (step S2517); and causes the series of process steps to come to an end.

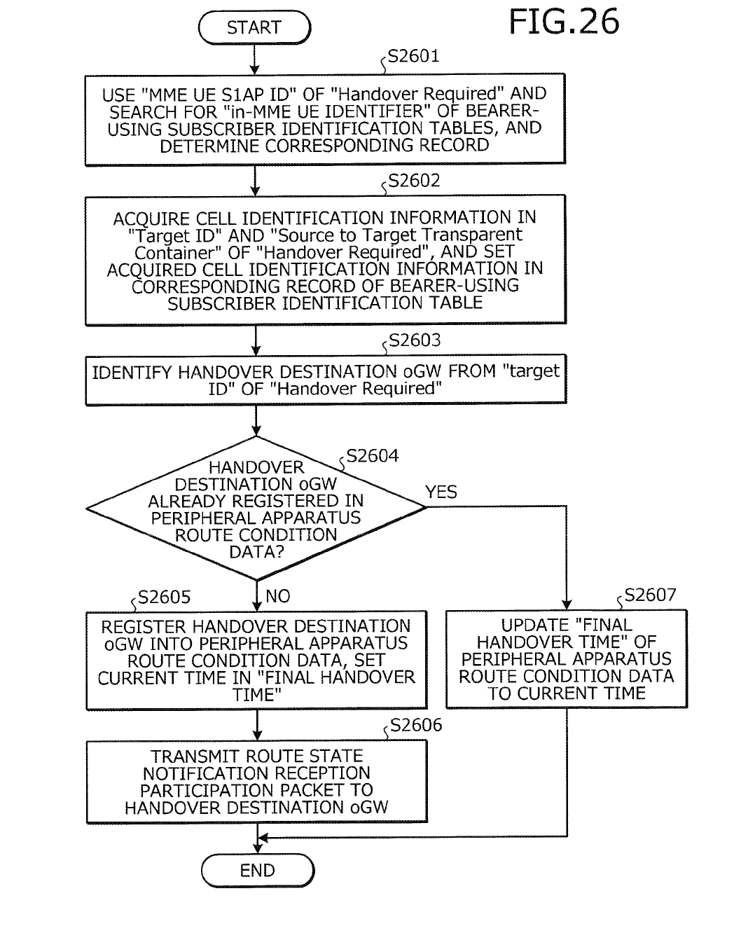

FIG. 26 is a flowchart of an example of a process executed when “Handover Required” is intercepted. When the off-load GW 500 intercepts “Handover Required” 2100 (see, e.g., FIG. 21), the off-load GW 500 uses the CPU 503 and executes, for example, steps depicted in FIG. 26.

The off-load GW 500 uses the “MME UE S1AP ID” of “Handover Required” 2100 and searches for the “in-MME UE identifier” of the bearer-using subscriber identification tables 1710, and determines the corresponding record (step S2601).

The off-load GW 500 acquires the cell identification information in “Target ID” and “Source to Target Transparent Container” of “Handover Required” 2100, and sets the acquired cell identification information in the corresponding record of the bearer-using subscriber identification table 1720 (step S2602). The off-load GW 500 sets the acquired cell identification information in the “target ID” and the “S-target cell identification information” of the corresponding record.

The off-load GW 500 identifies the handover destination oGW (off-load gateway) from the “target ID” of the “Handover Required” 2100 (step S2603).

The off-load GW 500 determines whether the handover destination oGW identified at step S2603 is already registered in the peripheral apparatus route condition data 609 (step S2604). If the off-load GW 500 determines that the handover destination oGW is not yet registered in the peripheral apparatus route condition data 609 (step S2604: NO), the off-load GW 500 registers the handover destination oGW into the peripheral apparatus route condition data 609, sets the current time in the “final handover time” (step S2605), transmits the route state notification reception participation packet 1800 to the handover destination oGW (step S2606), and causes the series of process steps to come to an end.

If the off-load GW 500 determines at step S2604 that the handover destination oGW is already registered in the peripheral apparatus route condition data 609 (step S2604: YES), the off-load GW 228 updates the “final handover time” of the peripheral apparatus route condition data 609 to the current time (step S2607) and causes the series of process steps to come to an end.

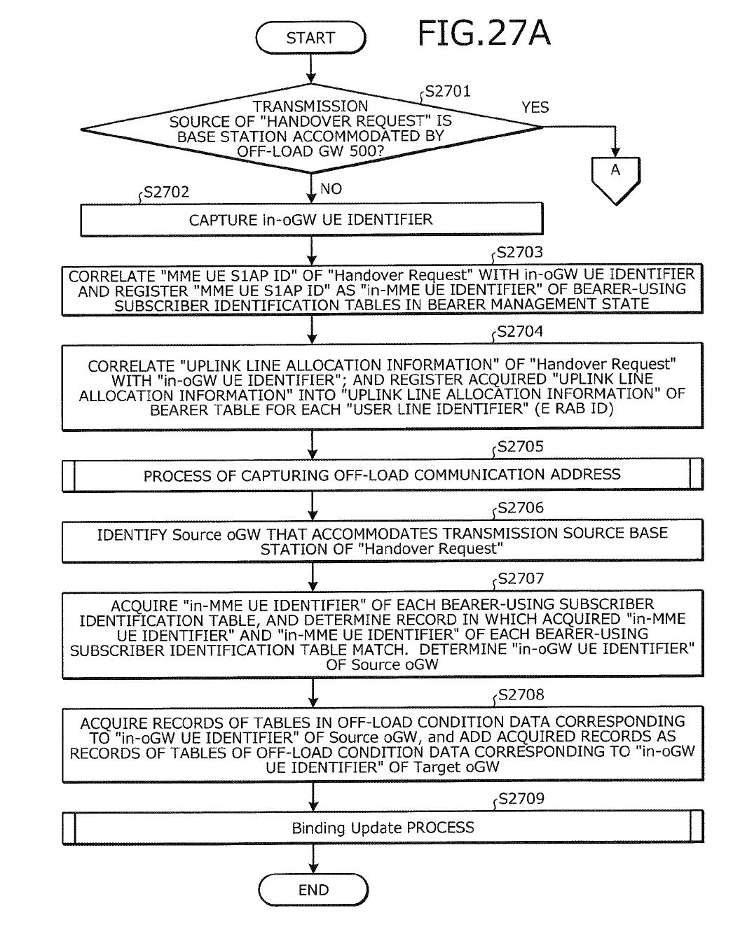

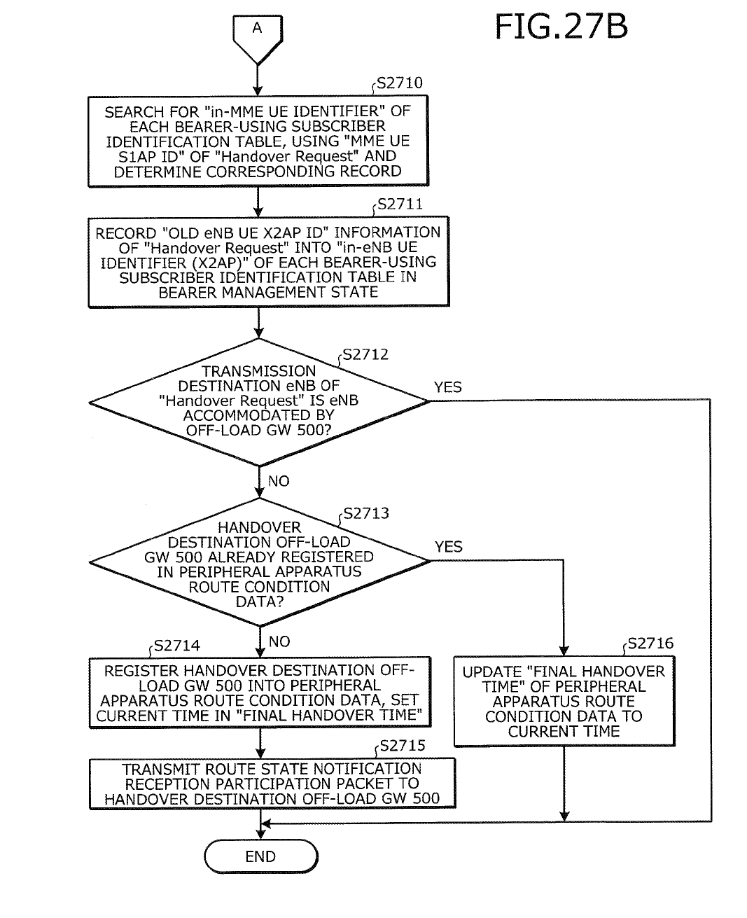

FIGS. 27A and 27B are a flowchart of an example of a process executed when the “Handover Request” is received based on the X2AP. When an X2-based handover is executed, the off-load GW 500 uses the X2AP intercepting unit 602 of the CPU 503 and executes, for example, the steps depicted in FIGS. 27A and 27B.

The off-load GW 500 determines whether the transmission source base station (transmission source eNB) of “Handover Request” 2400 is a base station (eNB) accommodated by the off-load GW 500 (the oGW) (step S2701). If the off-load GW 500 determines that the transmission source base station is not a base station accommodated by the off-load GW 500 (step S2701: NO), the off-load GW 500 captures the in-oGW UE identifier (step S2702).

The off-load GW 500 correlates the “MME UE S1AP ID” of “Handover Request” 2400 with the in-oGW UE identifier and registers the “MME UE S1AP ID” as the “in-MME UE identifier” of each of the bearer-using subscriber identification tables 1710 and 1720 in the bearer management state (step S2703).

The off-load GW 500 acquires the “uplink line allocation information” of “Handover Request” 2400; correlates the acquired “uplink line allocation information” with the “in-oGW UE identifier”; and registers the acquired “uplink line allocation information” into the “uplink line allocation information” of the bearer table 1730 for each “user line identifier” (ERAB ID) (step S2704). The bearer table 1730 is the bearer table 1730 included in the bearer state management data 606.

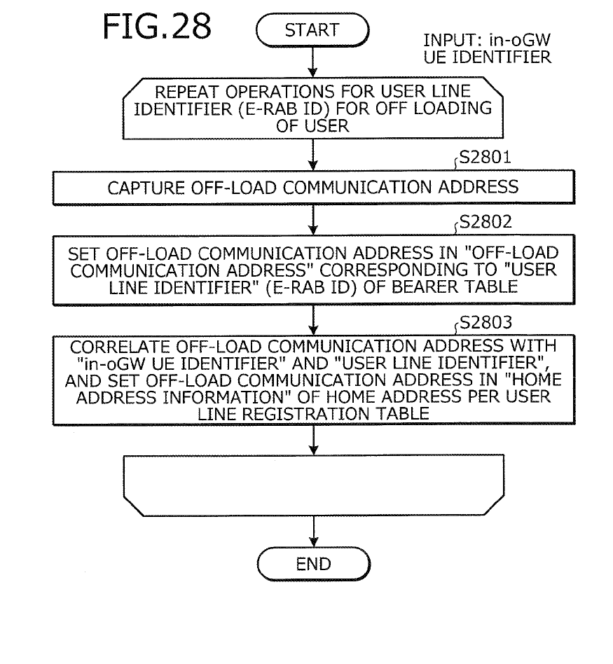

The off-load GW 500 executes a process of capturing the off-load communication address (step S2705). Thereby, for example, the off-load GW 500 can produce the care-of address. The home address is produced, for example, in a case where the off-load GW 500 (when the X2-based handover is executed) receives “Initial Context Setup Request” prior to the execution of the X2-based handover. The process of capturing the off-load communication address executed at step S2705 will be described later (see, e.g., FIG. 28).

The off-load GW 500 identifies another off-load GW 500 (source oGW) that accommodates the transmission source base station (transmission source eNB) of “Handover Request” 2400 (step S2706).

The off-load GW 500 acquires the “in-MME UE identifier” of each of the bearer-using subscriber identification tables 1710 and 1720, and determines a record in which the acquired “in-MME UE identifier” and the “in-MME UE identifier” of each of the bearer-using subscriber identification tables 1710 and 1720 match each other. Thereby, the off-load GW 500 determines the “in-oGW UE identifier” of the handover source (source) (step S2707).

The off-load GW 500 acquires records of the tables in the off-load condition data 607 corresponding to the “in-oGW UE identifier” of the handover source off-load GW 500 (source oGW), and adds the acquired records as records of the tables of the off-load condition data 607 corresponding to the “in-oGW UE identifier” of the handover destination off-load GW 500 (step S2708). The tables of the off-load condition data 607 are the home address per user line registration table 1610, the communication destination per user line registration table 1620, and the address port per user line conversion table 1630.

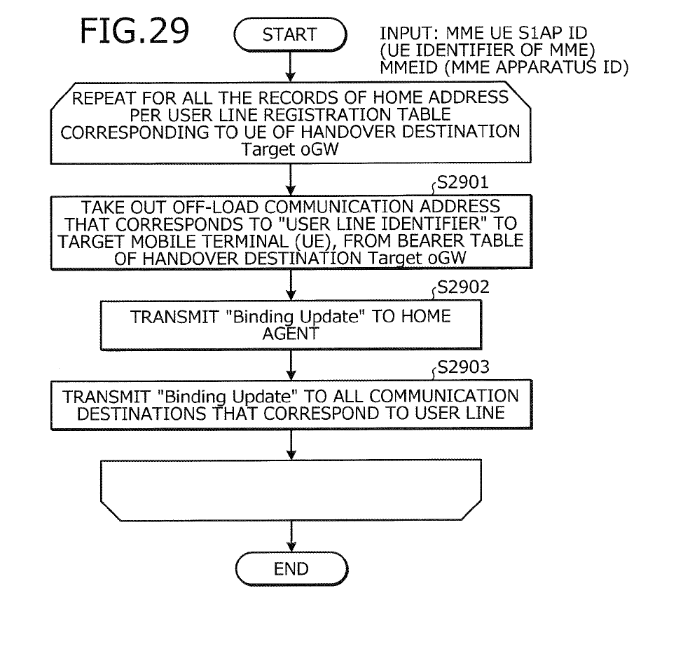

The off-load GW 500 executes a binding update process (step S2709) and causes the series of process steps to come to an end. Thereby, for example, the handover source off-load GW 500 can transmit the home address and the care-of address corresponding to the home address, to the web servers 241 and 242. For example, the handover source off-load GW 500 can transmit the home address and the care-of address to the handover destination off-load GW 500. The binding update process executed at step S2709 will be described later (see, e.g., FIG. 29).

If the off-load GW 500 determines at step S2701 that the transmission source base station is a base station accommodated by the off-load GW 500 (step S2701: YES), the off-load GW 500 progresses to the operation at step S2710. The off-load GW 500 searches for the “in-MME UE identifier” of each of the bearer-using subscriber identification tables 1710 and 1720 using the “MME UE S1AP ID” of the “Handover Request” 2400 and determines the corresponding record (step S2710).

The off-load GW 500 records “old eNB UE X2AP ID” information of “Handover Request” 2400 into the “in-eNB UE identifier (X2AP)” of each of the bearer-using subscriber identification tables 1710 and 1720 in the bearer management state (step S2711).

The off-load GW 500 determines whether the transmission destination base station (transmission destination eNB) of “Handover Request” 2400 is a base station (eNB) accommodated by the off-load GW 500 (the oGW) (step S2712). If the off-load GW 500 determines that the transmission destination base station is a base station accommodated by the off-load GW 500 (step S2712: YES), the off-load GW 500 causes the series of process steps to come to an end.

If the off-load GW 500 determines at step S2712 that the transmission destination base station is not a base station accommodated by the off-load GW 500 (step S2712: NO), the off-load GW 500 determines whether the handover destination off-load GW 500 (oGW) is already registered in the peripheral apparatus route condition data 609 (step S2713). If the off-load GW 500 determines that the handover destination off-load GW 500 is not yet registered in the peripheral apparatus route condition data 609 (step S2713: NO), the off-load GW 500 registers the handover destination oGW into the peripheral apparatus route condition data 609, sets the current time in the “final handover time” (step S2714), transmits the route state notification reception participation packet 1800 to the handover destination oGW (step S2715), and causes the series of process steps to come to an end.

If the off-load GW 500 determines at step S2713 that the handover destination off-load GW 500 is already registered in the peripheral apparatus route condition data 609 (step S2713: YES), the off-load GW 228 updates the “final handover time” of the peripheral apparatus route condition data 609 to the current time (step S2716), and causes the series of process steps to come to an end.

FIG. 28 is a flowchart of an example of an off-load communication address capture operation at step S2705 of FIGS. 27A and 27B. The off-load GW 500 executes, for example, the steps depicted in FIG. 28 as the off-load communication address capture process. The off-load GW 500 repeats the operations at steps S2801 to S2803 below for the user line identifier (E-RAB ID) for the off loading of the user.

The off-load GW 500 captures the off-load communication address (step S2801). For example, the off-load GW 500 requests a care-of address to the DHCP server, the home server, etc. and receives plural candidate care-of addresses, and selects a care-of address avoiding use of the same care-of address as any of those used by the other user line identifiers. The off-load GW 500 selects, for example, the care-of address avoiding use of the same address as the home address. The off-load communication address used in this process is, for example, the care-of address.

The off-load GW 500 sets the off-load communication address in the “off-load communication address” corresponding to the “user line identifier” (E-RAB ID) of the bearer table 1730 (step S2802). For example, the off-load GW 500 registers the selected care-of address into the corresponding “off-load communication address” of the bearer table 1730.

The off-load GW 500 correlates the off-load communication address with the “in-oGW UE identifier” and the “user line identifier” and sets the off-load communication address in the “home address information” of the home address per user line registration table 1610 (step S2803).

FIG. 29 is a flowchart of an example of the binding update operation at step S2709 depicted in FIGS. 27A and 27B. The off-load GW 500 executes, for example, steps depicted in FIG. 29 as the binding update process.

The off-load GW 500 repeats steps S2901 to S2903 below for all the records of the home address per user line registration table 1610 corresponding to the UE of the handover destination off-load GW 500 (target oGW).

The off-load GW 500 takes out an off-load communication address (for example, the care-of address) that corresponds to the “user line identifier” to the target mobile terminal (UE), from the bearer table 1730 of the handover destination off-load GW 500 (target oGW) (step S2901).

The off-load GW 500 (target oGW) transmits a “Binding Update” to a home agent (step S2902). The “home agent” is disposed in, for example, the handover source off-load GW 500. The off-load GW 500 (target oGW) transmits the “Binding Update” to all the communication destinations that correspond to the user line (step S2903).

Thereby, for example, the off-load GW 500 (target oGW) can transmit the home address and the care-of address supporting the home address to the handover source off-load GW 500 and the web server 241.

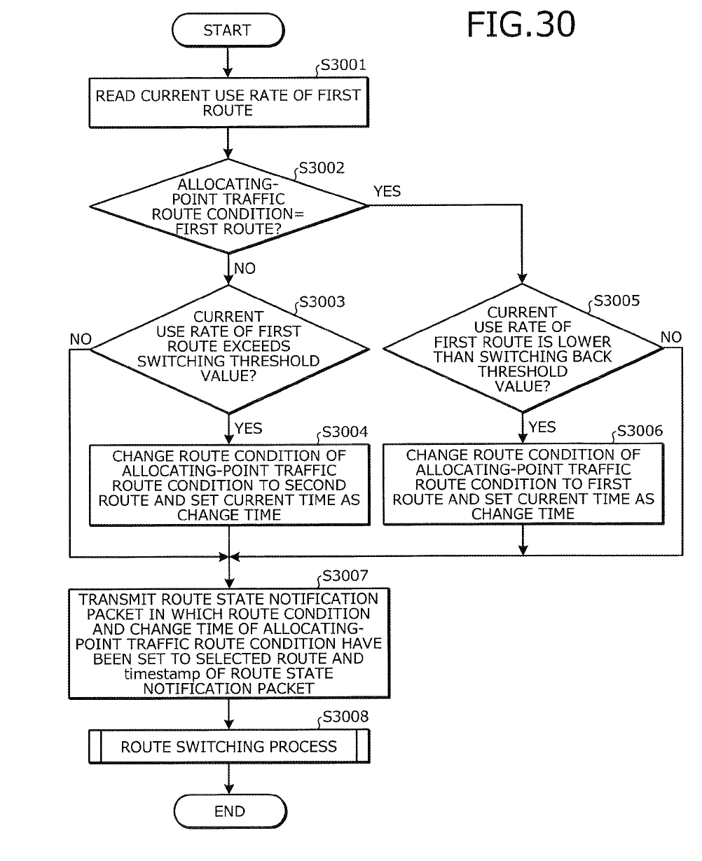

FIG. 30 is a flowchart of an example of an allocating-point traffic measurement process. The off-load GW 500 to be the handover destination (for example, the off-load GW 226), for example, periodically executes the allocating-point traffic measurement process depicted in FIG. 30. The off-load GW 500 reads the current use rate of the first route of the off-load GW 500 (step S3001). The current use rate is, for example, a ratio of the current traffic amount to the maximal traffic amount.

The off-load GW 500 determines whether the allocating-point traffic route condition indicated by the allocating-point traffic route condition data 610 (see, e.g., FIG. 10) is the first route (step S3002). If the off-load GW 500 determines that the allocating-point traffic route condition is not the first route (step S3002: NO), the off-load GW 500 progresses to the operation at step S3003. The off-load GW 500 determines whether the current use rate of the first route exceeds the switching threshold value represented by the allocating-point traffic route condition switching threshold value 1400 (see, e.g., FIG. 14) (step S3003). If the off-load GW 500 determines that the current use rate does not exceed the switching threshold value (step S3003: NO), the off-load GW 500 progresses to the operation at step S3007.

If the off-load GW 500 determines at step S3003 that the current use rate exceeds the switching threshold value (step S3003: YES), the off-load GW 500 progresses to the operation at step S3004. The off-load GW 500 changes the route condition of the allocating-point traffic route condition indicated by the allocating-point traffic route condition data 610 (see, e.g., FIG. 10), to the second route and sets the current time as the change time (step S3004).

If the off-load GW 500 determines at step S3002 that the allocating-point traffic route condition is the first route (step S3002: YES), the off-load GW 500 progresses to the operation at step S3005. The off-load GW 500 determines whether the current use rate of the first route is lower than the switching back threshold value represented by the allocating-point traffic route condition switching threshold value 1400 (see, e.g., FIG. 14) (step S3005). If the off-load GW 500 determines that the current use rate is not lower than the switching back threshold value (step S3005: NO), the off-load GW 500 progresses to the operation at step S3007.

If the off-load GW 500 determines at step S3005 that the current use rate is lower than the switching back threshold value (step S3005: YES), the off-load GW 500 progresses to the operation at step S3006. The off-load GW 500 changes the route condition of the allocating-point traffic route condition indicated by the allocating-point traffic route condition data 610 (see, e.g., FIG. 10), to the first route and sets the current time as the change time (step S3006).

The off-load GW 500 multicast-transmits the route state notification packet 2000 (see, e.g., FIG. 20) in which the route condition and the change time of the allocating-point traffic route condition have been (step S3007). For example, the off-load GW 500 sets the route condition of the allocating-point traffic route condition as the selected route of the route state notification packet 2000, and sets the change time of the allocating-point traffic route condition in the “timestamp” thereof.

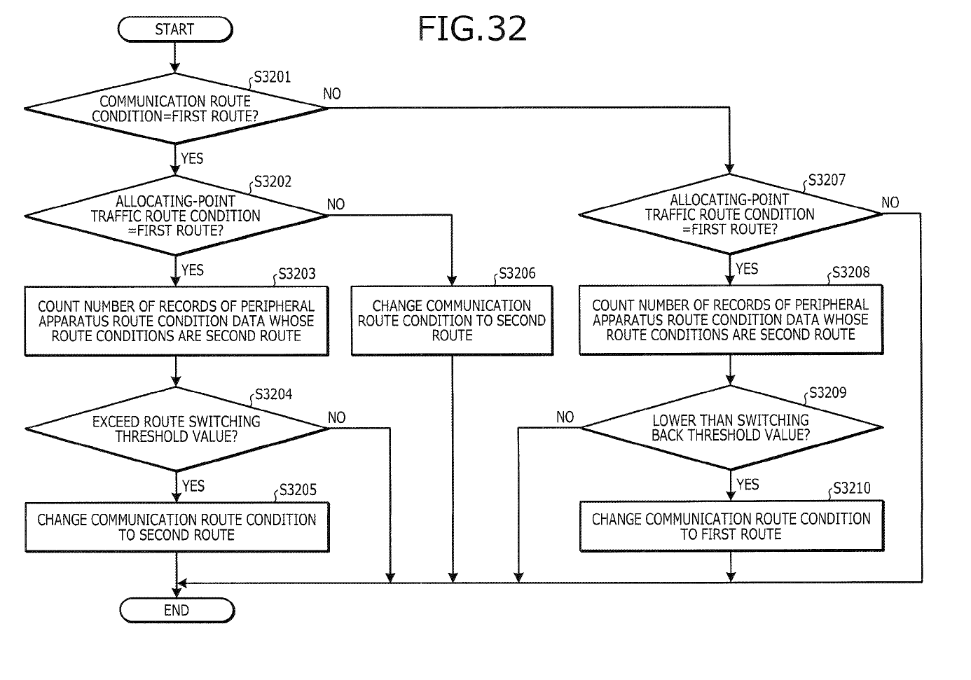

The off-load GW 500 executes a predetermined route switching process (step S3008) and causes the series of steps of the allocating-point traffic measurement process to come to an end. The route switching process executed at step S3008 will be described later (with reference to, for example, FIG. 32).

By executing the above steps, the allocating-point traffic route condition is determined based on the result of the comparison between the measurement result and the threshold value of the traffic of the first route. The route state notification packet 2000 indicating the determination result of the allocating-point traffic route condition, is multicast-distributed.

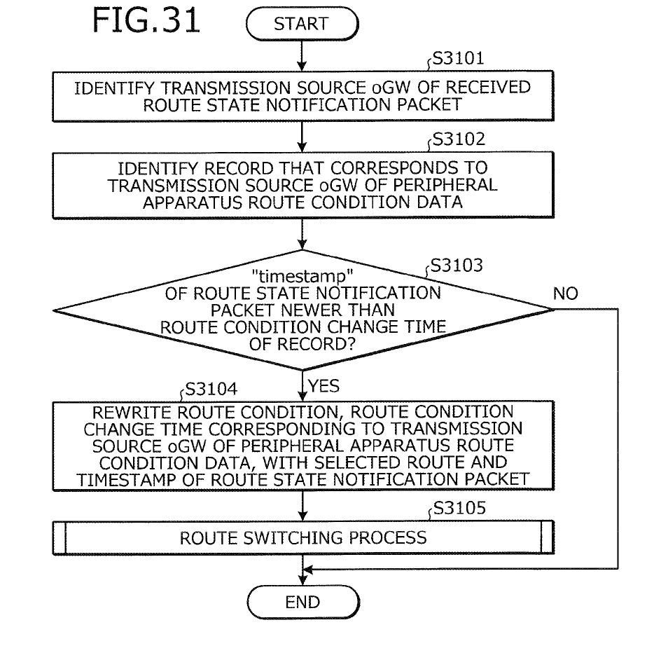

FIG. 31 is a flowchart of an example of a process executed when the route state notification packet is received. The off-load GW 500 executes, for example, steps depicted in FIG. 31 when the route state notification packet 2000 is received from another off-load GW 500. The off-load GW 500 identifies the transmission source off-load GW (transmission source oGW) of the received route state notification packet 2000 (step S3101), and identifies the record that corresponds to the transmission source oGW identified at step S3101 of the peripheral apparatus route condition data 609 (see, e.g., FIG. 11) (step S3102).

The off-load GW 500 determines whether the “timestamp” of the received route state notification packet 2000 is newer than the route condition change time of the record identified at step S3102 (step S3103). If the off-load GW 500 determines that the “timestamp” is older than the route condition change time (step S3103: NO), the off-load GW 500 causes the series of process steps for the reception of the route state notification packet 2000 to come to an end.

If the off-load GW 500 determines at step S3103 that the “timestamp” is newer than the route condition change time (step S3103: YES), the off-load GW 500 progresses to the operation at step S3104. The off-load GW 500 rewrites the record identified at step S3102 of the peripheral apparatus route condition data 609 based on the received route state notification packet 2000 (step S3104). For example, the off-load GW 500 rewrites the route condition of the record with the selected route of the received route state notification packet 2000 and rewrites the route condition change time of the record with the “timestamp” thereof.

The off-load GW 500 executes the predetermined route switching process (step S3105) and causes the series of process steps for the reception of the route state notification packet to come to an end. The route switching process executed at step S3105 will be described later (for example, FIG. 32).

FIG. 32 is a flowchart of an example of the route switching process. The off-load GW 500 executes, for example, the following steps as the route switching operation at step S3008 depicted in FIG. 30 and step S3105 depicted in FIG. 31.

The off-load GW 500 determines whether the communication route condition indicated by the communication route condition data 608 (see, e.g., FIG. 9) is the first route (step S3201). If the off-load GW 500 determines that the communication route condition is the first route (step S3201: YES), the off-load GW 500 determines whether the allocating-point traffic route condition indicated by the allocating-point traffic route condition data 610 (see, e.g., FIG. 10) is the first route (step S3202).

If the off-load GW 500 determines at step S3202 that the allocating-point traffic route condition is the first route (step S3202: YES), the off-load GW 500 progresses to the operation at step S3203. The off-load GW 500 counts the number of records of the peripheral apparatus route condition data 609 whose route conditions are the second route (see, e.g., FIG. 11) (step S3203).

The off-load GW 500 determines whether the result of the counting at step S3202 exceeds the route switching threshold value indicated by the peripheral apparatus traffic route condition communication route switching threshold value 1200 (see, e.g., FIG. 12) (step S3204). If the off-load GW 500 determines that the result of the counting does not exceed the route switching threshold value (step S3204: NO), the off-load GW 500 causes the series of process steps to come to an end.

If the off-load GW 500 determines at step S3204 that the result of the counting exceeds the route switching threshold value (step S3204: YES), the off-load GW 500 changes the communication route condition of the communication route condition data 608 to the second route (step S3205) and causes the series of process steps to come to an end.

If the off-load GW 500 determines at step S3202 that the allocating-point traffic route condition is not the first route (step S3202: NO), the off-load GW 500 changes the communication route condition of the communication route condition data 608 to the second route (step S3206) and causes the series of process steps to come to an end.

If the off-load GW 500 determines at step S3201 that the communication route condition is not the first route (step S3201: NO), the off-load GW 500 determines whether the allocating-point traffic route condition indicated by the allocating-point traffic route condition data 610 is the first route (step S3207).

If the off-load GW 500 determines at step S3207 that the allocating-point traffic route condition is the first route (step S3207: YES), the off-load GW 500 counts the number of records of the peripheral apparatus route condition data 609 whose route conditions are the second route (step S3208).

The off-load GW 500 determines whether the result of the counting at step S3202 is lower than the switching back threshold value represented by the peripheral apparatus traffic route condition communication route switching threshold value 1200 (step S3209). If the off-load GW 500 determines that the result of the counting is not lower than the switching back threshold value (step S3209: NO), the off-load GW 500 causes the series of process steps to come to an end.

If the off-load GW 500 determines at step S3209 that the result of the counting is lower than the switching back threshold value (step S3209: YES), the off-load GW 500 changes the communication route condition of the communication route condition data 608 to the first route (step S3210) and causes the series of process steps to come to an end.

If the off-load GW 500 determines at step S3207 that the allocating-point traffic route condition is not the first route (step S3207: NO), the off-load GW 500 causes the series of process steps to come to an end.

By executing the above process steps, for example, the second route can be selected for the currently relayed communication corresponding to the number of off-load GWs 500 that each acquires the second route of the plural off-load GWs 500 (route selecting apparatuses) for the handover.

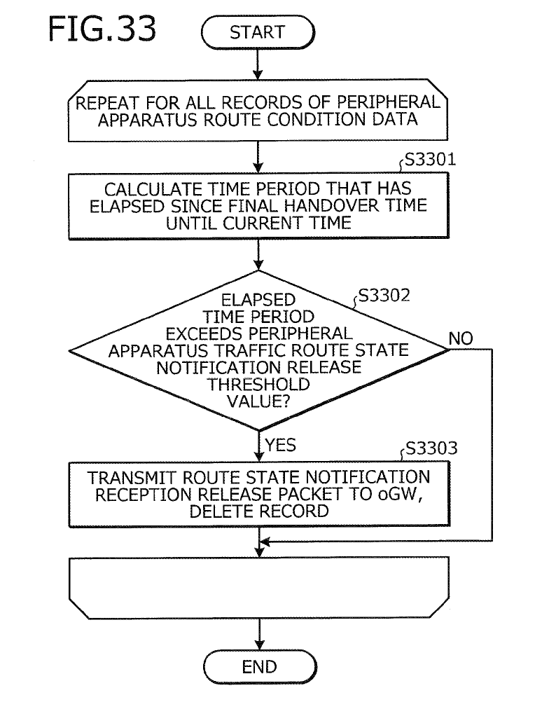

FIG. 33 is a flowchart of an example of a route state reception release process. The off-load GW 500, for example, periodically executes steps depicted in FIG. 33. For example, the off-load GW 500 repeats operations at steps S3301 to S3303 below for all the records of the peripheral apparatus route condition data 609.

The off-load GW 500 calculates the time period that has elapsed since the final handover time of the record under processing, until the current time (step S3301), and determines whether the elapsed time period calculated at step S3301 exceeds the peripheral apparatus traffic route state notification release threshold value 1300 (see, e.g., FIG. 13) (step S3302). If the off-load GW 500 determines that the calculated elapsed time period does not exceed the peripheral apparatus traffic route state notification release threshold value 1300 (step S3302: NO), the off-load GW 500 causes the process for the record under processing to come to an end.

If the off-load GW 500 determines at step S3302 that the calculated elapsed time period exceeds the peripheral apparatus traffic route state notification release threshold value 1300 (step S3302: YES), the off-load GW 500 progresses to the operation at step S3303. The off-load GW 500 transmits the route state notification reception release packet 1900 (see, e.g., FIG. 19), deletes the record under processing from the peripheral apparatus route condition data 609 (step S3303), and causes the process for the record under processing to come to an end.

Examples of operations of the network system 200 will be described.

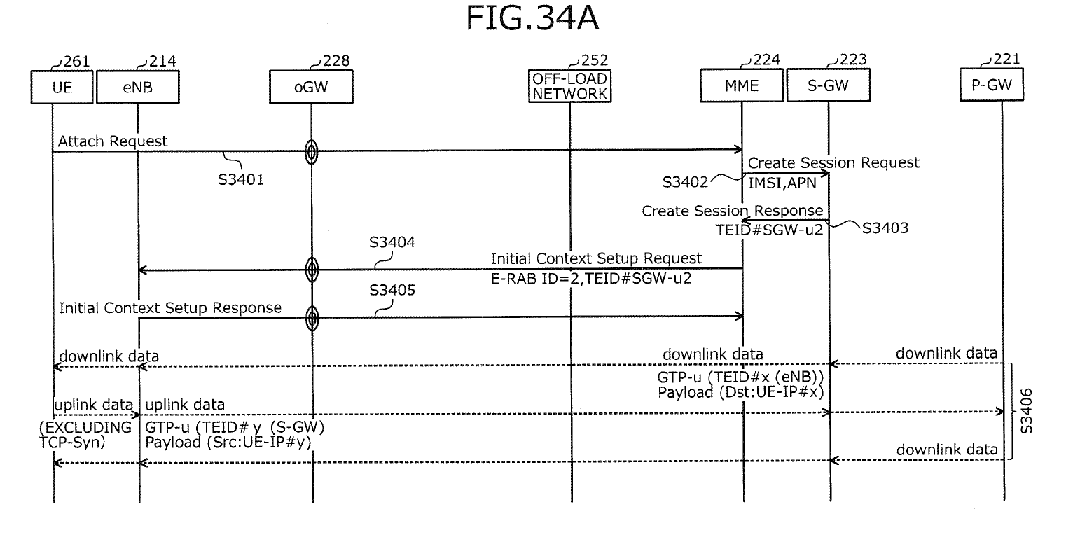

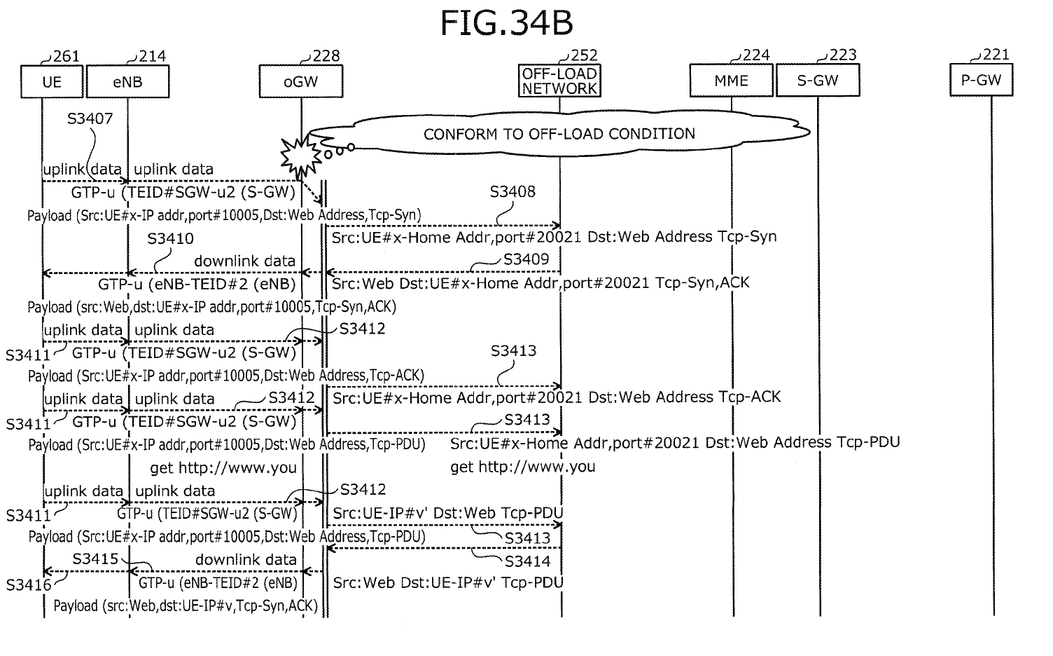

FIGS. 34A and 34B are sequence diagrams of an example of operations of the network system, executed when the TCP communication is off-loaded. The operations from the startup of the mobile terminal 261 (UE) to the off-loading of the TCP communication for the off-loading will be described with reference to FIGS. 34A and 34B.

When the mobile terminal 261 starts up, the mobile terminal 261 executes a procedure for connecting to the base station 214 (eNB). The mobile terminal 261 transmits “Attach Request” (a connection request message) to the base station 214 (step S3401). “Attach Request” transmitted at step S3401 is transmitted to the MME 224 through the base station 214.

The MME 224 transmits “Create Session Request” to the S-GW 223 (step S3402). The S-GW 223 transmits “Create Session Response” to the MME 224 (step S3403).

The MME 224 produces “Initial Context Setup Request” and transmits this to the base station 214 (step S3404). The off-load GW 228 intercepts “Initial Context Setup Request” transmitted at step S3404, and executes registration into each of the bearer-using subscriber identification tables 1710 and 1720, and the bearer table 1730, based on the content of the intercepted “Initial Context Setup Request”.

The base station 214 transmits “Initial Context Setup Response” to the MME 224 (step S3405). The off-load GW 228 intercepts “Initial Context Setup Response” transmitted at step S3405, and executes registration into the bearer table 1730, based on the content of the intercepted “Initial Context Setup Response”.

The mobile terminal 261 starts a connection with web server 241 through the P-GW 221 (step S3406). The base station 214 transmits a GTP-u packet (see, e.g., FIG. 22) toward the S-GW 222 (step S3407). The off-load GW 228 receives the GTP-u packet transmitted from the base station 214 and executes the processes depicted in FIGS. 25A and 25B.

The off-load packet (ICP/IP packet) arrives at the web server 241 through the off-load network 252 (step S3408). The downlink off-load packet arrives at the off-load GW 228 from the web server 241 through the off-load network 252 (step S3409).

The off-load GW 228 transmits a downlink GTP-u packet toward the base station 214 (step S3410). Thereby, the TCP communication through the off-load network 252 is established.

The sequence example of the data concerning the connection request has been described with reference to steps S3407 to S3410. A case will be described where user data other than the connection request is transmitted. The uplink data traveling from the mobile terminal 261 toward the web server 242 is transmitted, for example, as follows.

The base station 214 receives the uplink data transmitted from the mobile terminal 261 (step S3411) and transmits the GTP-u packet to the S-GW 223 (step S3412). The off-load GW 228 receives the GTP-u packet transmitted by the base station 214, executes the processes depicted in FIGS. 25A and 25B, and transmits the off-load packet to the web server 241 through the off-load network 252 (step S3413).

The downlink data traveling from the web server 241 to the mobile terminal 261 will be described. The downlink data is transmitted, for example, as follows.

The off-load GW 228 receives the off-load packet through the off-load network 252 (step S3414) and transmits the GTP-u packet to the base station 214 (step S3415). The base station 214 transmits the downlink data to the mobile terminal 261 (step S3416).

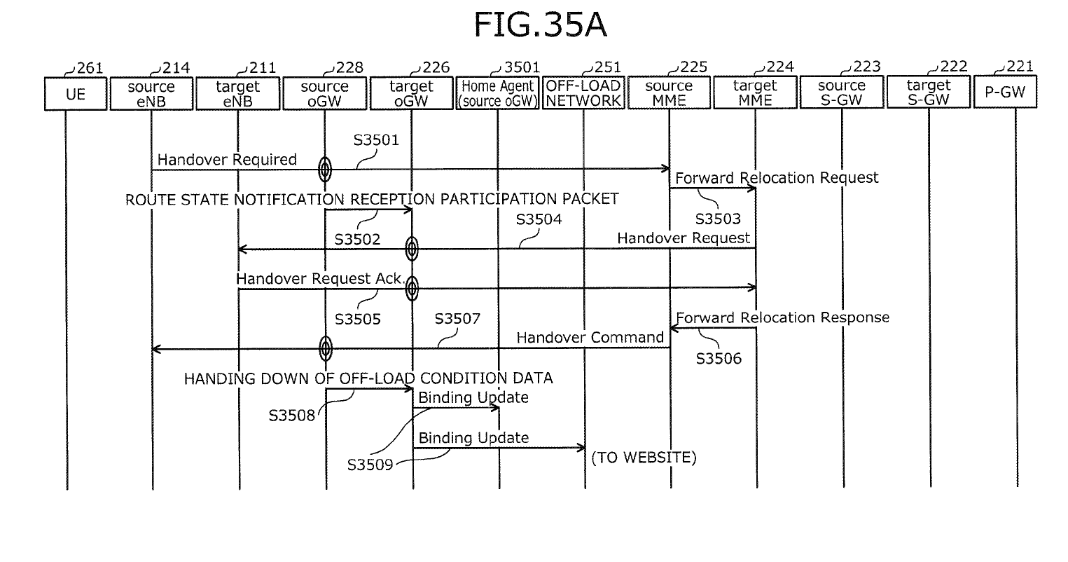

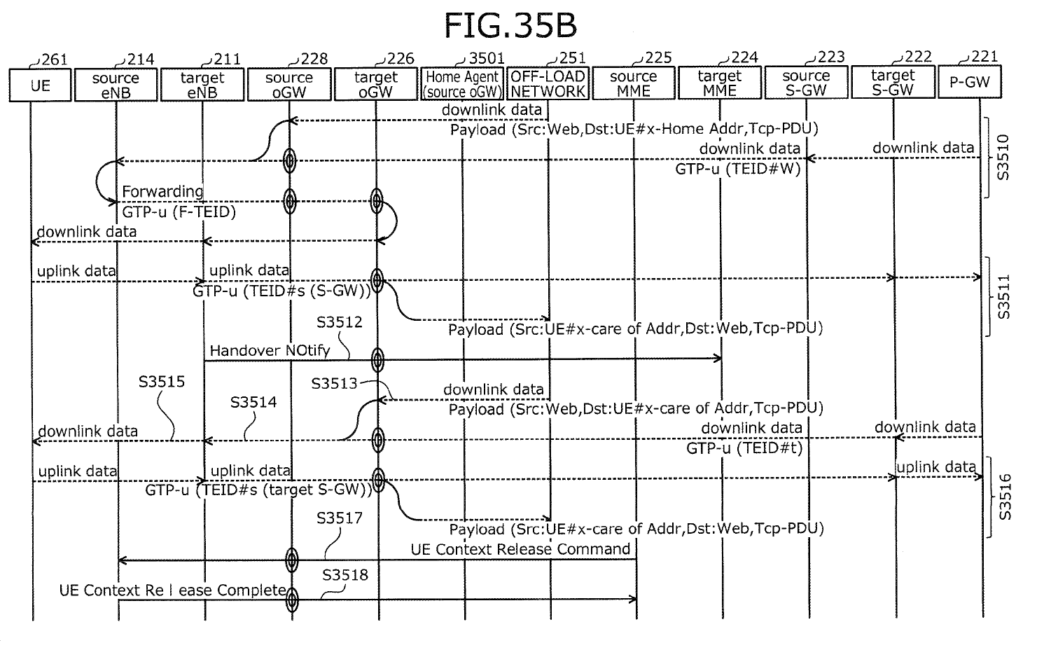

FIGS. 35A and 35B are sequence diagrams of an example of the S1-based handover process. In FIGS. 35A and 35B, an example of handing down of the off-load condition data 607 in the S1-based handover will be described.

It is assumed that the handover source base station 214 (source eNB) starts the S1-based handover, associated with the movement of the mobile terminal 261 (UE). In this case, the base station 214 transmits “Handover Required” (see, e.g., FIG. 21) to the MME 225, (source MME) relayed by the handover source off-load GW 228 (source oGW) (step S3501).

At step S3501, the off-load GW 228 intercepts “Handover Required” and executes the process depicted in FIG. 26. The off-load GW 228 transmits the route state notification reception participation packet 1800 to the handover destination off-load GW 226 (target oGW) (step S3502).

The MME 225 transmits “Forward Relocation Request” to the handover destination MME 224 (target MME) (step S3503). The MME 224 transmits “Handover Request” to the handover destination base station 211 (target eNB) through the off-load GW 226 (target oGW) (step S3504). The base station 211 transmits “Handover Request Ack.” to the MME 224, through the off-load GW 226 (step S3505).

The MME 224 transmits “Forward Relocation Response” to the MME 225 (step S3506). The MME 225 transmits “Handover Command” to the base station 214 (step S3507).

The off-load GW 228 intercepts “Handover Command” transmitted at step S3507 and executes handing down of the off-load condition data 607 to the off-load GW 226 (step S3508).

The off-load GW 226 learns the home address information for each traffic to be off-loaded, and transmits “Binding Update” to the communication destination web server 241 (off-load network 251) and a home agent 3501 of the off-load GW 228 that manages the home address (step S3509).

For downlink data of the mobile terminal 261, the route from the S-GW 223 and the route from the off-load network 251 join each other at the off-load GW 228 to form the route for the downlink data that is to be transferred to the base station 211 through the base station 214 and the off-load GW 226 (step S3510).

The uplink data of the mobile terminal 261 is transferred from the base station 211 to the off-load GW 226 and is branched at the off-load GW 226 into those for the route through the S-GW 222 and for the route through the off-load network 251 (step S3511).

When the handover destination base station 211 causes the process executed in response to “Handover Request” to come to an end, the base station 211 transmits “Handover Notify” that is a completion message to the MME 224 (step S3512). Thereby, the destination address of the downlink data is switched from the base station 214 to the base station 211.

The transmission operation of the downlink off-load packet executed in this case will be described. The web server 241 transmits the off-load packet addressing this packet to the care-of address (step S3513). When the off-load GW 226 receives the off-load packet from the web server 241, the off-load GW 226 transmits the GTP-u packet to the base station 211 (step S3514). The base station 211 transmits the downlink data to the mobile terminal 261 (step S3515). The transmission operation for the uplink data executed in this case by the mobile terminal 261 is same as the process executed at step S3511 (step S3516).

The MME 225 transmits “UE Context Release Command” to the base station 214 to release the resource secured for the mobile terminal 261 (step S3517). The base station 214 transmits “UE Context Release Complete” to the MME 225 (step S3518).

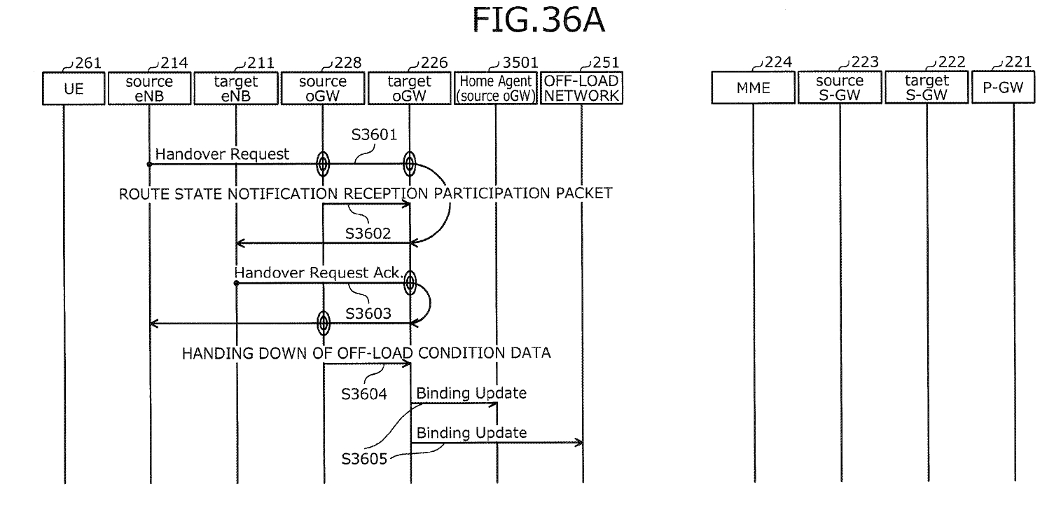

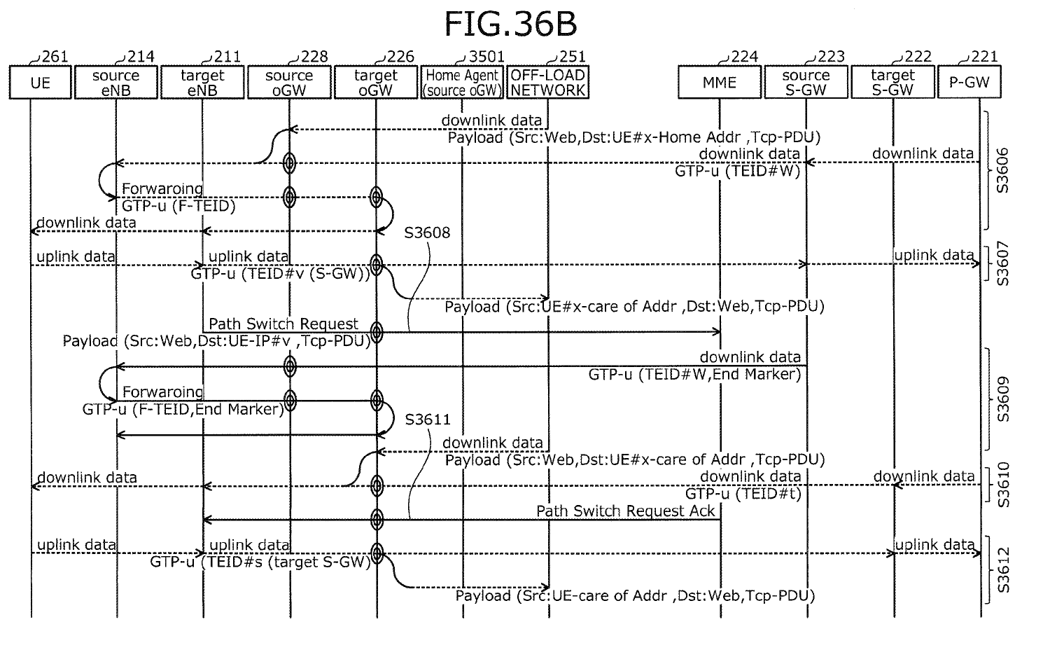

FIGS. 36A and 36B are sequence diagrams of an example of the X2-based handover process. An example of handing down of the off-load condition data 607 in the X2-based handover will be described with reference to FIGS. 36A and 36B. It is assumed that the handover source base station 214 starts the X2-based handover, associated with the movement of the mobile terminal 261 (UE).

In this case, the base station 214 transmits “Handover Request” (see, e.g., FIG. 24) of the X2AP to the handover destination base station 211 (step S3601). “Handover Request” transmitted at step S3601 is received by the base station 211 through the off-load GWs 228 and 226.

The off-load GW 228 intercepts “Handover Request” transmitted at step S3601 and executes the processes depicted in FIGS. 27A and 27B. Thereby, the route state notification reception participation packet 1800 (see, e.g., FIG. 18) is transmitted from the off-load GW 228 to the off-load GW 226 (step S3602).

The base station 211 transmits “Handover Request Ack.” of the X2AP to the handover source base station 214 (step S3603). “Handover Request Ack.” transmitted at step S3603 is received by the base station 214 through the off-load GWs 226 and 228.

The off-load GW 228 intercepts “Handover Request Ack.” transmitted at step S3603 and executes handing down of the off-load condition data 607 to the off-load GW 226 (step S3604).

The off-load GW 226 learns the home address information for each traffic to be off-loaded, and transmits “Binding Update” to the communication destination web server 241 (off-load network 251) and the home agent 3501 of the off-load GW 228 that manages the home address (step S3605).

Thereafter, the downlink data from the off-load network 251 and the P-GW 221 arrive at the mobile terminal 261 through the base station 214, the off-load GWs 228 and 226, and the base station 211 (step S3606). The uplink data from the mobile terminal 261 is transmitted to the off-load network 251 and the P-GW 221 through the base station 211 and the off-load GW 226 (step S3607).

The base station 211 transmits “Path Switch Request” toward the MME 224 through the off-load GW 226 (step S3608).

In this case, a route is formed for the downlink data to be transmitted along the GWs and base stations in the sequence of the S-GW 223, the off-load GW 228, the base station 214, the off-load GW 228, the off-load GW 226, and the base station 211 (step S3609).

For downlink data of the mobile terminal 261, the route from the S-GW 222 and the route from the off-load network 251 join each other at the off-load GW 226 to form the route for the downlink data that is to be transferred to the base station 211 (step S3610).

The MME 224 transmits “Path switch Request Ack.” to the base station 211 through the off-load GW 226 (step S3611). The off GW 226 intercepts “Path Switch Request Ack.” and switches the “uplink line allocation information” of the bearer table 1730 corresponding to the in-oGW UE identifier of the off-load GW 226.

The uplink data of the mobile terminal 261 is transferred from the base station 211 to the off-load GW 226 and is branched at the off-load GW 226 into those for the route through the S-GW 222 and for the route through the off-load network 251 (step S3612).

An example will be described of the state transition of the peripheral apparatus route condition data 609, the allocating-point traffic route condition data 610, and the communication route condition data 608 in the handover source and the handover destination off-load GWs 228 and 226.

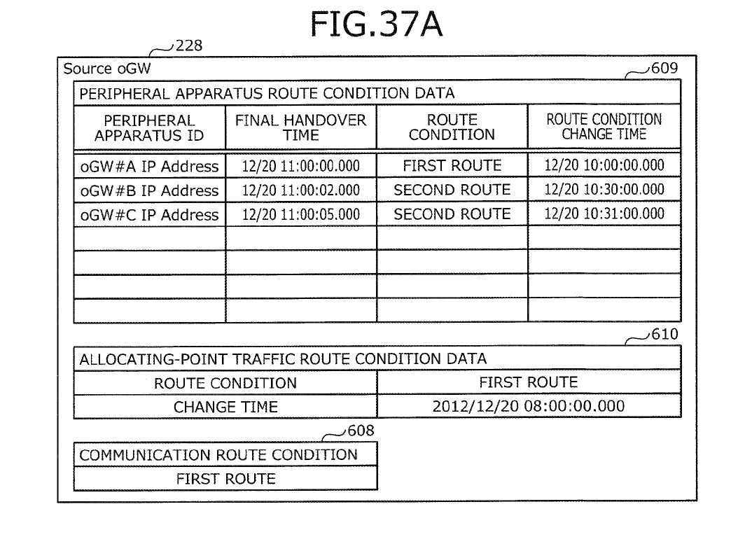

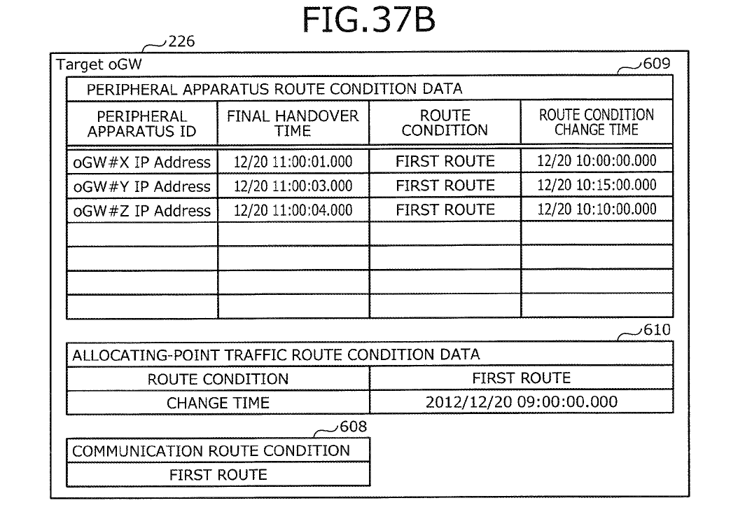

FIGS. 37A and 37B are diagrams of an example of the state before the first handover session. In the example depicted in FIGS. 37A and 37B, it is assumed for both of the off-load GWs 228 (source oGW) and 226 (target oGW) that the route condition of the allocating-point traffic route condition data 610 and the communication route condition data 608 indicate the first route.

In the state depicted in FIGS. 37A and 37B, when the base station 214 starts the S1-based handover process depicted in FIGS. 35A and 35B associated with the movement of the mobile terminal 261, the base station 214 transmits “Handover Required” (see, e.g., FIG. 21) to the MME 225. The off-load GW 228 intercepts “Handover Required” transmitted from the base station 214 to the MME 225 and executes the process depicted in FIG. 26.

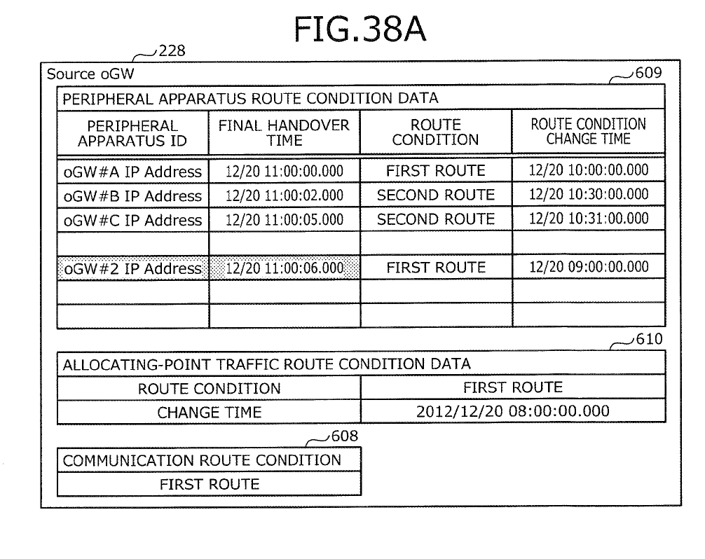

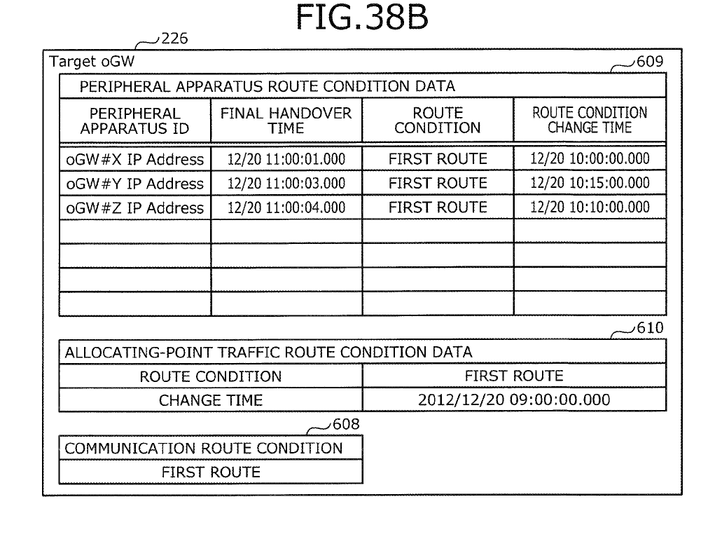

FIGS. 38A and 38B are diagrams of an example of the state after the first handover session. By executing the process depicted in FIG. 26, as depicted in FIGS. 38A and 38B, the off-load GW 228 registers the off-load GW 226 (oGW #2) into the peripheral apparatus route condition data 609; sets the final handover time therein; and transmits the route state notification reception participation packet 1800 (see, e.g., FIG. 18).

When the off-load GW 228 receives the route state notification packet 2000 from the off-load GW 226, the off-load GW 228 executes the process depicted in FIG. 31. Thereby, as depicted in FIGS. 38A and 38B, the off-load GW 228 sets the route condition and the route condition change time, based on the route state notification packet 2000 in the record corresponding to the off-load GW 226 of the peripheral apparatus route condition data 609.

A case where the base station 214 starts the S1-based handover process depicted in FIGS. 35A and 35B has been described with reference to FIGS. 37 and 38. However, the case where the base station 214 starts the X2-based handover process depicted in FIGS. 36A and 36B is same as the above case.

In the state depicted in FIGS. 37A and 37B, when the base station 214 starts the X2-based handover process associated with the movement of the mobile terminal 261, the base station 214 transmits “Handover Request” (see, e.g., FIG. 24) of the X2AP to the base station 211. The off-load GW 228 intercepts “Handover Request” of the X2AP transmitted from the base station 214 to the base station 211 and executes the process depicted in FIGS. 27A and 27B.

By executing the processes depicted in FIGS. 27A and 27B, as depicted in FIGS. 38A and 38B, the off-load GW 228 registers the off-load GW 226 (oGW #2) into the peripheral apparatus route condition data 609; sets the final handover time therein; and transmits the route state notification reception participation packet 1800 (see, e.g., FIG. 18).

When the off-load GW 228 receives the route state notification packet 2000 from the off-load GW 226, the off-load GW 228 executes the process depicted in FIG. 31. Thereby, as depicted in FIGS. 38A and 38B, the off-load GW 228 sets based on the route state notification packet 2000, the route condition and the route condition change time in the record corresponding to the off-load GW 226 of the peripheral apparatus route condition data 609.

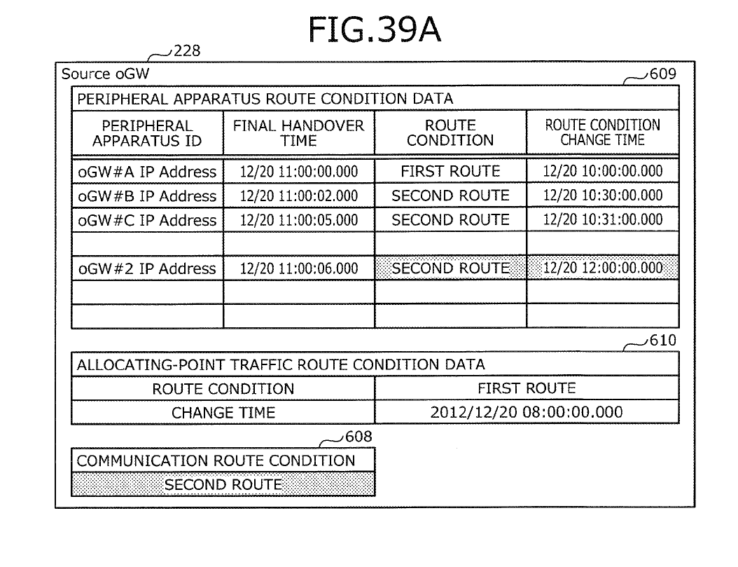

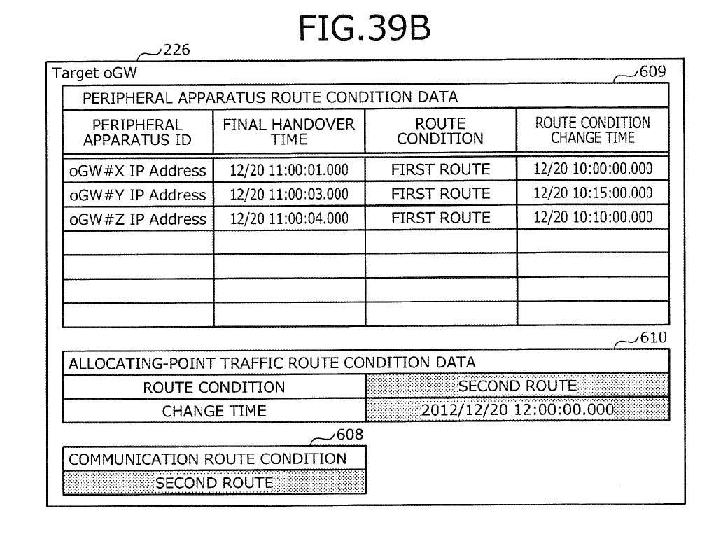

FIGS. 39A and 39B are diagrams of an example of the state after the route switching due to the traffic of the first route at the handover destination off-load GW. The handover destination off-load GW 226 periodically executes the process depicted in FIG. 30 and compares the traffic use rate of the first route and the route switching threshold value (see, e.g., FIG. 14) with each other.

When the traffic use rate of the first route exceeds the route switching threshold value, as depicted in FIGS. 39A and 39B, the off-load GW 226 sets the route condition of the allocating-point traffic route condition data 610 and the communication route condition data 608 to be the second route, and produces and transmits the route state notification packet 2000 (see, e.g., FIG. 20) according to the allocating-point traffic route condition data 610.

When the off-load GW 228 receives the route state notification packet 2000 from the off-load GW 226, the off-load GW 228 executes the processes depicted in FIGS. 31 and 32 and thereby, as depicted in FIGS. 39A and 39B, rewrites the peripheral apparatus route condition data 609. When the number of records of the peripheral apparatus route condition data 609 whose route conditions are the second route, exceeds the route switching threshold value (see, e.g., FIG. 12), as depicted in FIGS. 39A and 39B, the off-load GW 228 switches the communication route condition of the communication route condition data 608 to the second route.

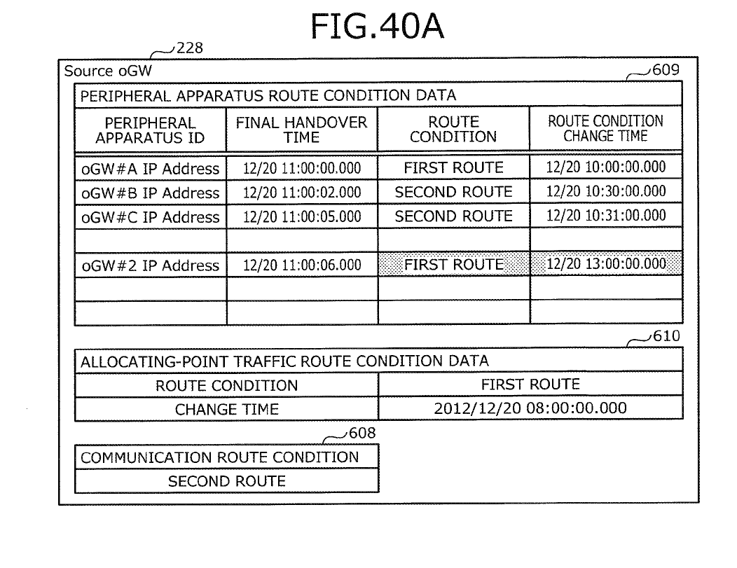

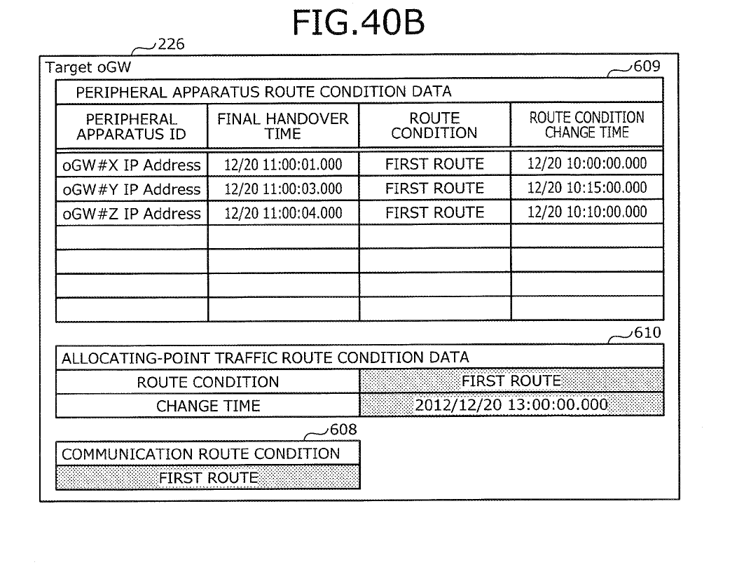

FIGS. 40A and 40B are diagrams of an example of the state after the route switching back due to the traffic of the first route at the handover destination off-load GW. The handover destination off-load GW 226 periodically executes the process depicted in FIG. 30 and compares the traffic use rate of the first route and the switching back threshold value (see, e.g., FIG. 14) with each other.

When the traffic use rate of the first route is lower than the switching back threshold value, as depicted in FIGS. 40A and 40B, the off-load GW 226 sets the route condition of the allocating-point traffic route condition data 610 and the communication route condition data 608 to be the first route, and produces and transmits the route state notification packet 2000 (see, e.g., FIG. 20) according to the allocating-point traffic route condition data 610.

When the off-load GW 228 receives the route state notification packet 2000 from the off-load GW 226, the off-load GW 228 executes the processes depicted in FIGS. 31 and 32 and thereby, as depicted in FIGS. 40A and 40B, rewrites the peripheral apparatus route condition data 609.

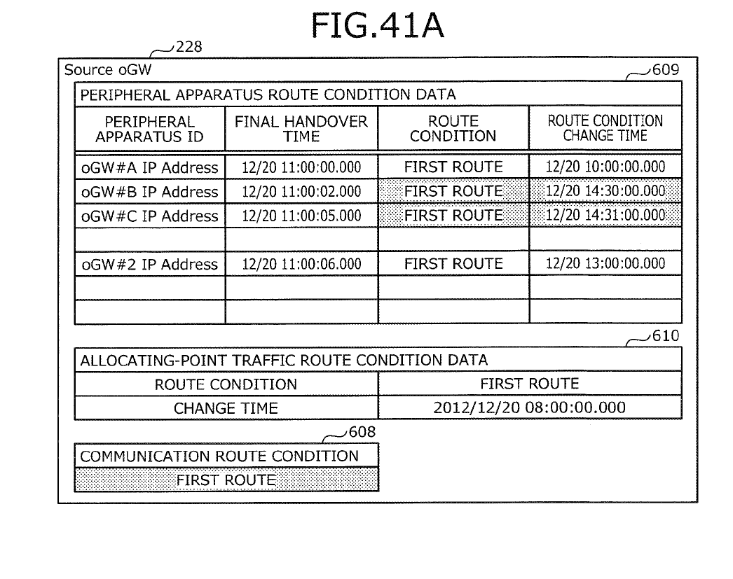

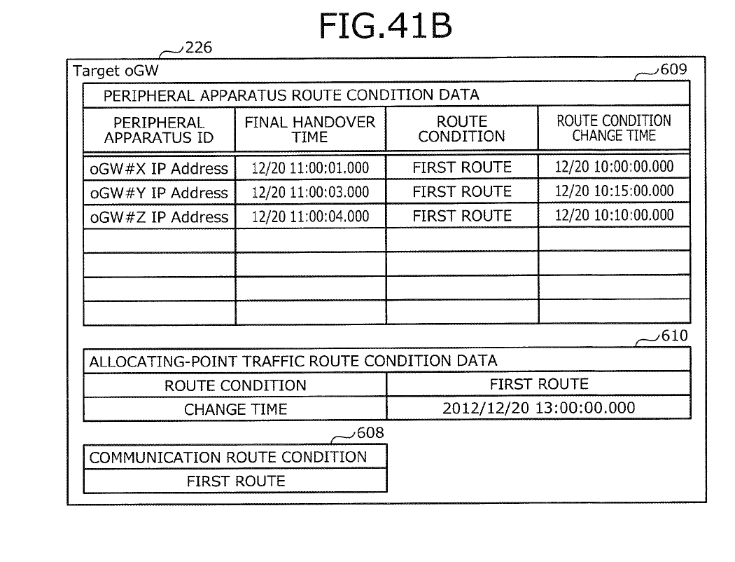

FIGS. 41A and 41B are diagrams of an example of the state after the route switching back due to the traffic of the first route at the peripheral apparatus. In the state depicted in FIGS. 40A and 40B, the off-load GW 500 near the off-load GW 228 (for example, the off-load GW 227) periodically executes the process depicted in FIG. 30 and compares the traffic use rate of the first route and the switching back threshold value (see, e.g., FIG. 14) with each other.

When the traffic use rate of the first route is lower than the switching back threshold value, the nearby off-load GW 500 produces and transmits the route state notification packet 2000 (see, e.g., FIG. 20) according to the allocating-point traffic route condition data 610.

When the off-load GW 228 receives the route condition state notification packet 2000 from the nearby off-load GW 500, the off-load GW 228 executes the processes depicted in FIGS. 31 and 32 and thereby, rewrites the peripheral apparatus route condition data 609 as depicted in FIGS. 41A and 41B. When the number of records of the peripheral apparatus route condition data 609 whose route conditions are the second route, is lower than the switching back threshold value (see, e.g., FIG. 12), the off-load GW 228 switches the communication route condition of the communication route condition data 608 to the first route as depicted in FIGS. 41A and 41B.

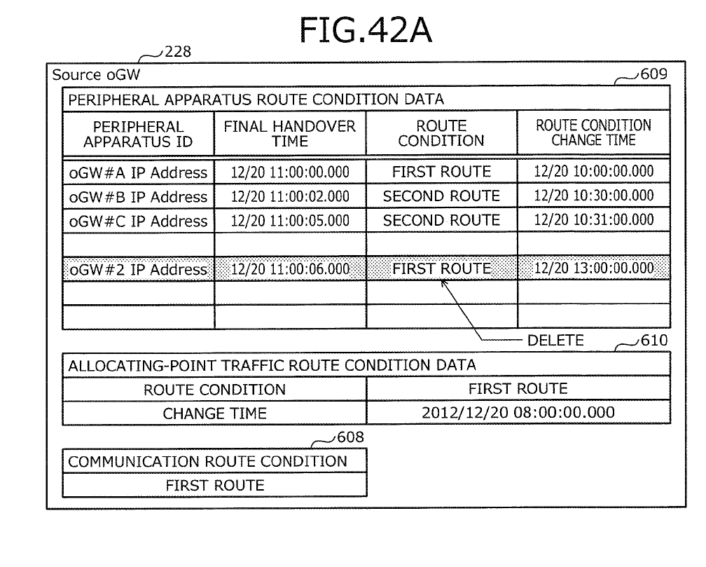

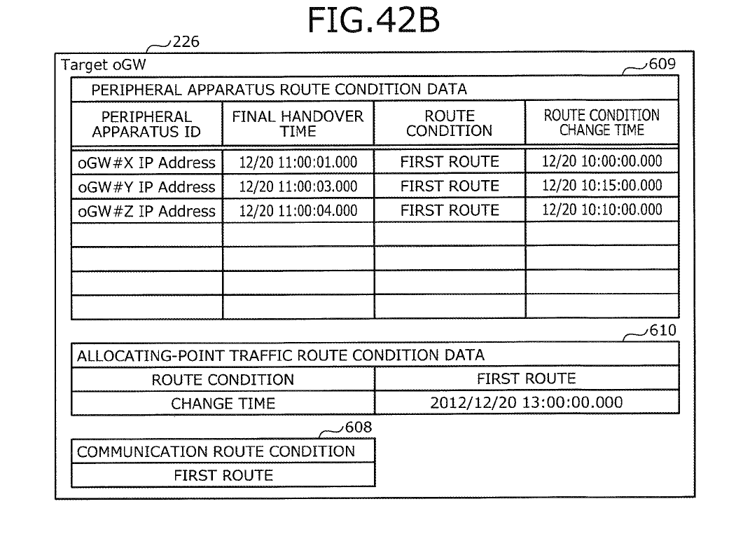

FIGS. 42A and 42B are diagrams of an example of the state where a predetermined time period has elapsed since the final handover time. In the state depicted in FIGS. 41A and 41B, the off-load GW 228 periodically executes the process depicted in FIG. 33, and determines that the time period elapsing since the final handover time for the off-load GW 226 exceeds the peripheral apparatus traffic route state notification release threshold value 1300 (see, e.g., FIG. 13).

In this case, as depicted in FIGS. 42A and 42B, the off-load GW 228 deletes the record of the off-load GW 226 from the peripheral apparatus route condition data 609, and produces and transmits the route state notification reception release packet 1900 (see, e.g., FIG. 19).

As described, according to the route selecting apparatus, the route selecting method, and the communication system, any congestion at the handover destination can be suppressed.

According to an aspect of the present embodiments, an effect is achieved that congestion at a handover destination can be suppressed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A first route selecting apparatus included among a plurality of route selecting apparatuses, the first route selecting apparatus comprising:
an acquiring unit that acquires for handover of communication currently relayed by the first route selecting apparatus, a selection state of a relay route of a second route selecting apparatus that is included among the plurality of route selecting apparatuses that each selects from among a first route and a second route, a relay route between a mobile terminal and a communication destination, and that when a traffic amount of the first route becomes at least a predetermined amount, selects the second route for communication established for a communication request issued thereafter; and
a selecting unit that according to the acquired selection state, selects the second route for the currently relayed communication even when the traffic amount of the first route is less than the predetermined amount.

2. The route selecting apparatus according to claim 1, wherein
the acquiring unit receives the selection state, which is multicast-distributed by the second route selecting apparatus.

3. The route selecting apparatus according to claim 1, wherein
the selecting unit selects the second route for the currently relayed communication when the second route selecting apparatus selects the second route.

4. The route selecting apparatus according to claim 1, wherein
the acquiring unit acquires the selection state for route selecting apparatuses that are among the plurality of route selecting apparatuses and that are to be handed over, and
the selecting unit selects the second route according to a count of the route selecting apparatuses that are to be handed over and that have selected the second route.

5. The route selecting apparatus according to claim 4, wherein
the selecting unit selects the second route when the count of the route selecting apparatuses that have selected the second route exceeds a predetermined number.

6. The route selecting apparatus according to claim 4, wherein
the selecting unit selects the first route when the count of the route selecting apparatuses that have selected the second route is less than a predetermined number and the traffic amount of the first route is less than the predetermined amount.

7. A route selecting method of a first route selecting apparatus that is included among a plurality of route selecting apparatuses that each selects from among a first route and a second route, a relay route between a mobile terminal and a communication destination, and that when a traffic amount of the first route becomes at least a predetermined amount, selects the second route for communication established for a communication request issued thereafter, the route selecting method comprising:
acquiring for handover of communication currently relayed by the first route selecting apparatus, a selection state of a relay route of a second route selecting apparatus that is included among the plurality of route selecting apparatuses; and
selecting according to the acquired selection state, the second route for the currently relayed communication even when the traffic amount of the first route is less than the predetermined amount.

8. A communication system comprising:
a plurality of route selecting apparatuses that each selects from among a first route and a second route, a relay route between a mobile terminal and a communication destination, and that when a traffic amount of the first route becomes at least a predetermined amount, selects the second route for communication established for a communication request issued thereafter, wherein
each of the route selecting apparatuses is configured to:
acquire for handover of communication currently relayed by the route selecting apparatus, a selection state of a relay route of another route selecting apparatus that is included among the route selecting apparatuses; and
select according to the acquired selection state, the second route for the currently relayed communication even when the traffic amount of the first route is less than the predetermined amount.
